(19) United States
(12) Patent Application Publication
(10) Pub. No.: US 2026/0188954 A1
(43) Pub. Date: Jul. 2, 2026

(54) CONNECTOR ASSEMBLY

(71) Applicant: Molex, LLC, Lisle, IL (US)

(72) Inventors: Hien-Hwee Tan, Jurong Town (SG); Javier Resendez, Streamwood, IL (US); Joseph Faia, Fox Lake, IL (US)

(21) Appl. No.: 19/355,664

(22) Filed: Oct. 10, 2025

Related U.S. Application Data
(63) Continuation of application No. 19/156,413, filed on Aug. 14, 2025.
(60) Provisional application No. 63/503,635, filed on May 22, 2023.

(51) Int. Cl. H01R 13/6471; H01R 13/10

(52) U.S. Cl. CPC H01R 13/6471; H01R 13/10

(57) ABSTRACT

Connector assemblies for high speed data communication are described. In one example, a plug connector includes a housing, a mating interface, a conductive gasket positioned on an outer surface of the housing in a region of the mating interface, a wafer assembly positioned in the housing. The wafer assembly includes channel shields, a pair of signal terminals extending within each of the channel shields, a signal terminal insert extending within each of the channel shields, and a conductive cable clamp positioned over the plurality of channel shields. The housing can be embodied as a conductive plated plastic housing in one example, and each of the channel shields is electrically coupled to the conductive plated plastic housing. The enhanced shielding provided by the conductive gasket, the plated plastic housing, and other features in the plug connector helps to maintain signal integrity and higher data throughput for the connector assemblies described herein.

### BACKGROUND

A range of input/output (I/O) connectors are designed for power, data, and power and data interconnect systems, including board-to-board, wire-to-wire, and wire-to-board systems. A variety of designs exist for each type of system, depending on the requirements of the power and data communications environment in which the connectors are used. As one example, a wire-to-board system includes a free-end connector attached to a wire and a fixed-end connector attached to a board.

High data rate connectors, cable assemblies, and interconnection systems often rely upon differentially coupled signal pairs in which two conductors are arranged in a pair to transmit a differential signal. The signal being transmitted is embodied by the electrical difference measured between the conductor pair. Differential signaling can be helpful to avoid spurious signals and crosstalk and avoid inadvertent signaling modes among adjacent signals pairs. In connector interfaces, ground terminals can be relied upon to create a return path to electrical ground, provide shielding between differential pairs, and for other purposes.

Connectors used in high data rate applications are typically designed to meet a range of mechanical and electrical requirements. High data rate connectors are often used in backplane applications, as one example, that require very high conductor density and data rates. To achieve the desired mechanical and electrical requirements, the connectors used in such applications often incorporate one or more wafer assemblies. The use of wafer assemblies can be helpful to manufacture connectors capable of achieving high data rates using a number of different assembly processes.

### SUMMARY

Various aspects and embodiments of connector assemblies are described. In one example, a plug connector includes a housing, a mating interface, a conductive gasket positioned on an outer surface of the housing in a region of the mating interface, and a wafer assembly positioned in the housing. The wafer assembly includes channel shields, a pair of signal terminals extending within each of the channel shields, a signal terminal insert extending within each of the channel shields, and a conductive cable clamp positioned over the plurality of channel shields. The housing can be embodied as a conductive plated plastic housing in one example. Additionally, of the channel shields can be electrically coupled to the conductive plated plastic housing.

In other aspects, the channel shields can include insert tabs that extend into and provide an interference fit with the conductive cable clamp. The wafer assembly can include a wafer overmold molded over the conductive cable clamp. In other aspects, each of the channel shields extends through an aperture in the conductive gasket in the region of the mating interface. The conductive gasket can be embodied as a foam multi-laminate having conductive materials disposed in the foam multi-laminate in one example.

In another example, a connector assembly includes a plug connector and a socket connector. The plug connector includes a plug housing, a plug mating interface, a conductive gasket positioned on an outer surface of the housing in a region of the mating interface, and a wafer assembly positioned in the housing. The socket connector includes a socket housing and a socket mating interface. The conductive gasket is positioned between the plug mating interface and the socket mating interface. The plug housing can be embodied as a conductive plated plug plastic housing. The socket housing can be embodied as a conductive plated socket plastic housing. The conductive gasket can be embodied as a foam multi-laminate having conductive materials disposed in the foam multi-laminate.

The wafer assembly can include channel shields, a pair of signal terminals extending within each of the plurality of channel shields, a signal terminal insert extending within each of the channel shields, and a conductive cable clamp positioned over the plurality of channel shields. Additionally, the plug housing can be embodied as a conductive plated plug plastic housing, and each of the channel shields can be electrically coupled to the conductive plated plug plastic housing. In other aspects, each of the channel shields includes insert tabs that extend into and provide an interference fit with the conductive cable clamp. The wafer assembly can also include a wafer overmold molded over the conductive cable clamp. In still other aspects, the channel shields can extend through apertures in the conductive gasket in the region of the mating interface. Additionally, the channel shields can include a contact dimples, the socket housing can be embodied as a conductive plated socket plastic housing, and the contact dimples can contact surfaces of the conductive plated socket plastic housing.

In another example, a connector includes a housing, a conductive gasket positioned on an outer surface of the housing, and a wafer assembly positioned in the housing. The wafer assembly includes a channel shields, a pair of signal terminals extending within each of the channel shields, and a conductive cable clamp positioned over the plurality of channel shields. The housing can be embodied as a conductive plated plastic housing. Each of the channel shields can be electrically coupled to the conductive plated plastic housing. Additionally, the channel shields can extend through apertures in the conductive gasket.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A illustrates a top perspective view of an example connector assembly according to various aspects of the present disclosure.

FIG. 1B illustrates a bottom perspective view of an example connector assembly according to various aspects of the present disclosure.

FIG. 1C illustrates a perspective view of the plug connector assembly and the socket connector assembly shown in FIGS. 1A and 1B according to various aspects of the present disclosure.

FIG. 2A illustrates a top perspective view of the plug connector assembly shown in FIGS. 1A-1C, with the plug housing cover separated, according to various aspects of the present disclosure.

FIG. 2B illustrates a bottom perspective view of the plug connector assembly shown in FIGS. 1A-1C according to various aspects of the present disclosure.

FIG. 2C illustrates a perspective view of the plug connector assembly shown in FIGS. 1A-1C, with parts omitted, according to various aspects of the present disclosure.

FIG. 2D illustrates a side view of the plug connector assembly shown in FIGS. 1A-1C, with parts omitted, according to various aspects of the present disclosure.

FIG. 2E illustrates a side view of a wafer assembly and conductive elastomeric gasket in the plug connector assembly shown in FIGS. 1A-1C according to various aspects of the present disclosure.

FIG. 2F illustrates a front view of a wafer assembly in the plug connector assembly shown in FIGS. 1A-1C according to various aspects of the present disclosure.

FIG. 2G illustrates a back view of a wafer assembly in the plug connector assembly shown in FIGS. 1A-1C according to various aspects of the present disclosure.

FIG. 2H illustrates a wafer assembly in the plug connector assembly shown in FIGS. 1A-1C, with parts omitted, according to various aspects of the present disclosure.

FIG. 2I illustrates the wafer assembly shown in FIG. 2H, with parts omitted, according to various aspects of the present disclosure.

FIG. 2J illustrates a channel shield and cable of the wafer assembly shown in FIG. 2H, with parts omitted, according to various aspects of the present disclosure.

FIG. 3A illustrates a front perspective view of a conductive cable clamp of the wafer assembly shown in FIG. 2H according to various aspects of the present disclosure.

FIG. 3B illustrates a back perspective view of the conductive cable clamp shown in FIG. 3A according to various aspects of the present disclosure.

FIG. 4A illustrates a top view of the plug housing of the plug connector shown in FIGS. 1A and 1B according to various aspects of the present disclosure.

FIG. 4B illustrates the cross-sectional view designated A-A in FIG. 4A according to various aspects of the present disclosure.

FIG. 5A illustrates a top view of the socket connector shown in FIGS. 1A and 1B according to various aspects of the present disclosure.

FIG. 5B illustrates the cross-sectional view designated B-B in FIG. 5A according to various aspects of the present disclosure.

FIG. 5C illustrates signal chicklet and shield terminal assemblies in the socket connector shown in FIG. 5A according to various aspects of the present disclosure.

FIG. 5D illustrates a signal chicklet and shield terminal assembly in the socket connector shown in FIG. 5A according to various aspects of the present disclosure.

FIG. 6 illustrates a cross sectional view through the connector assembly shown in FIG. 1A according to various aspects of the present disclosure.

### DETAILED DESCRIPTION

Connectors are typically designed to meet a range of mechanical and electrical requirements. High data rate connectors are often used in backplane applications, as one example, that require very high conductor density and data rates. To achieve the desired mechanical and electrical requirements, the connectors used in such applications often incorporate one or more wafer assemblies. The wafer assemblies can include an insulative web that supports the terminal conductors in the wafer assemblies. The use of wafer assemblies can be helpful to manufacture connectors capable of high data rates using a range of different assembly processes. It is still challenging, in any case, to design connectors having the conductor density and small footprint needed for high data rate applications in new systems, while also maintaining the desired electrical characteristics for the transmission of high data rates with suitable signal integrity.

In the context outlined above, various aspects and embodiments of high speed connector assemblies are described. In one example, a plug connector includes a housing, a mating interface, a conductive gasket positioned on an outer surface of the housing in a region of the mating interface, a wafer assembly positioned in the housing. The wafer assembly includes channel shields, a pair of signal terminals extending within each of the channel shields, a signal terminal insert extending within each of the channel shields, and a conductive cable clamp positioned over the plurality of channel shields. The housing can be embodied as a conductive plated plastic housing in one example, and each of the channel shields is electrically coupled to the conductive plated plastic housing. The enhanced shielding provided by the conductive gasket, the plated plastic housing, and other features in the plug connector helps to maintain signal integrity and higher data throughput for the connector assemblies described herein.

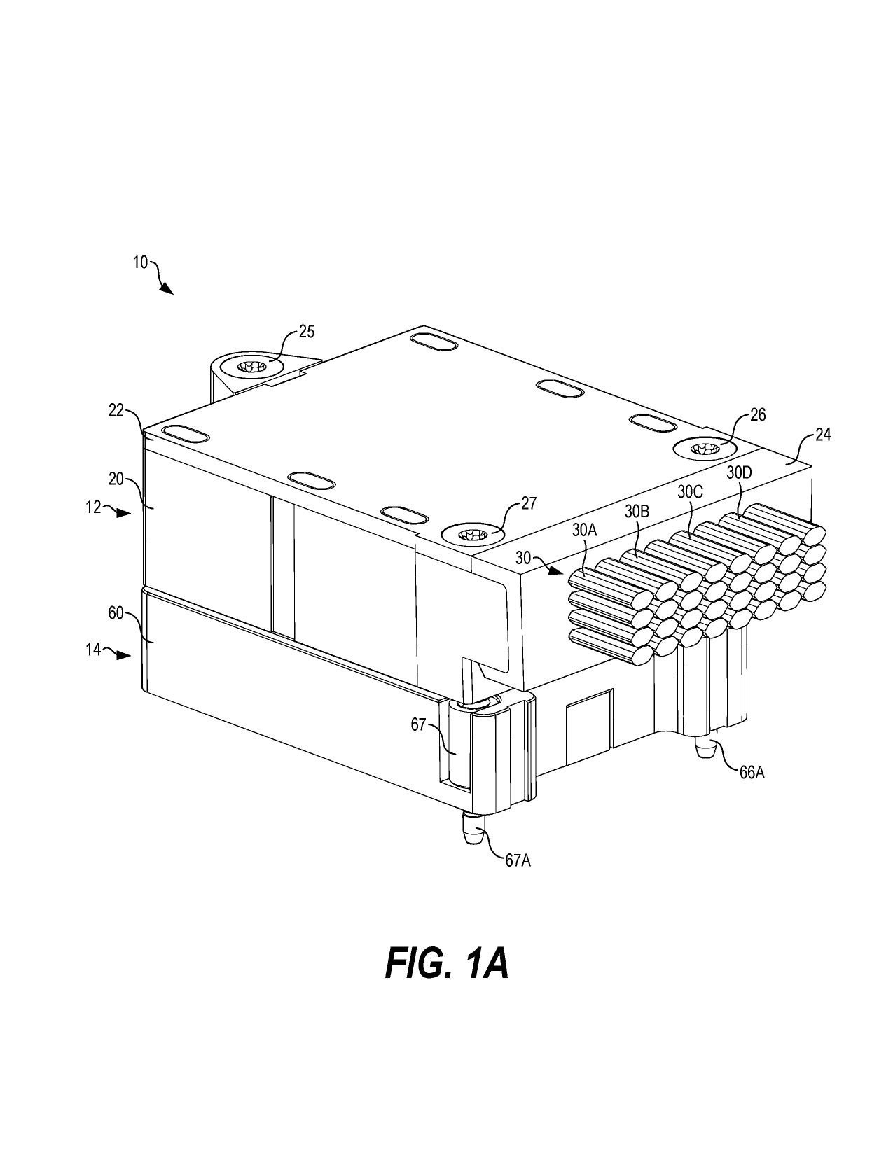

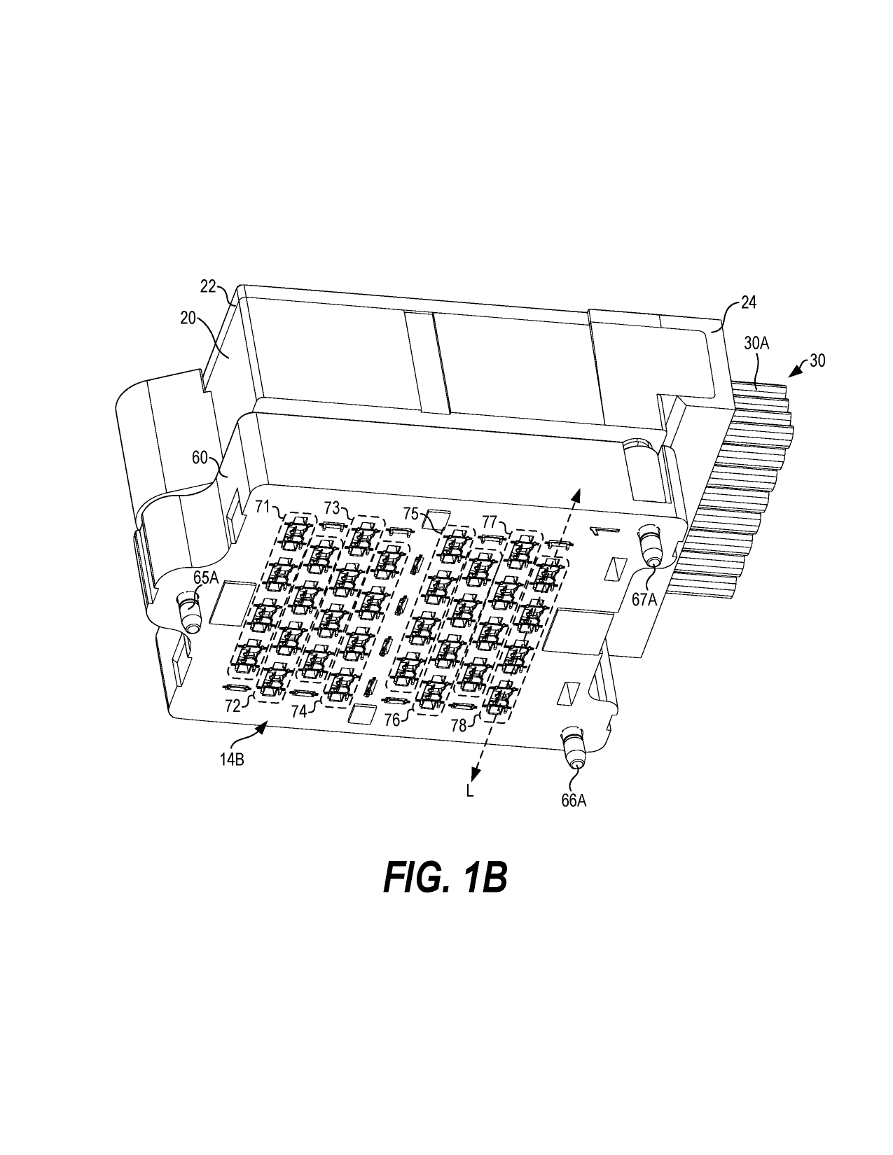

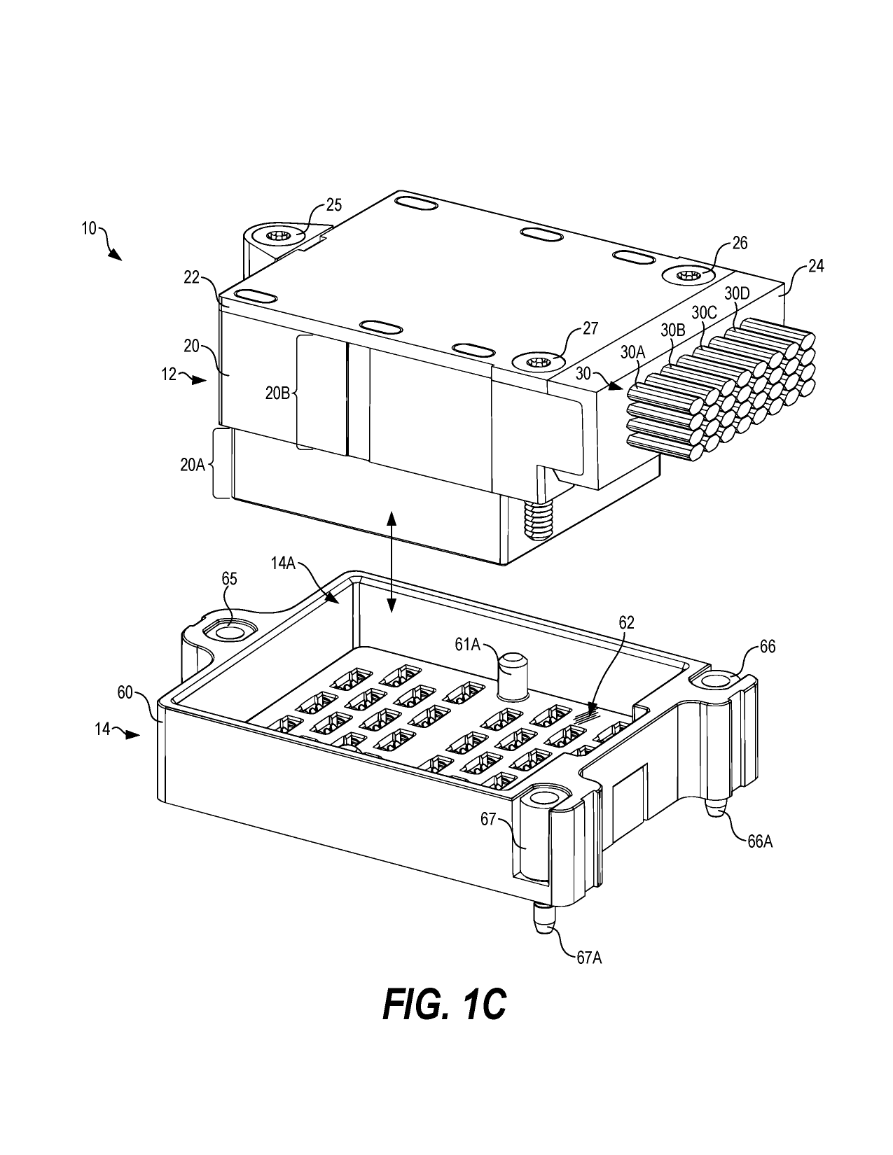

Turning to the drawings, FIG. 1A illustrates a top perspective view of an example connector assembly 10, and FIG. 1B illustrates a bottom perspective view the connector assembly 10 shown in FIG. 1A. The connector assembly 10 is illustrated as a representative example and is not drawn to any particular scale or size. The shape, size, proportion, and other characteristics of the connector assembly 10 can vary as compared to that shown. Additionally, while the connector assembly 10 and other connectors discussed herein are described for use in high speed backplane and related interconnect applications, the concepts are not limited to use with such interconnect applications or systems. The concepts can be extended to use in other types of connectors for other types of interconnect applications or systems.

The connector assembly 10 includes a plug connector assembly 12 (also “plug connector 12”) and a socket connector assembly 14 (also “socket connector 14”). The plug connector 12 includes a plug housing 20, a plug housing cover 22, plug anchors 25-27, a cable bundle 30, and a cable bundle anchor 24, among other components described below. The socket connector 14 includes a socket housing 60 and socket anchors 65-67, among other components described below. The plug connector assembly 12 can be connected with the socket connector 14, as shown in FIG. 1A. Referring to FIG. 1B, a surface mating interface 14B of the socket connector 14 can be surface mounted to a printed circuit board (PCB).

The plug connector assembly 12 is a plug connector at the free end of an interconnect cable, particularly at the free end of the cable bundle 30. The cable bundle 30 includes a number of cables, including the cables 30A-30D, among others. The cable bundle 30 includes thirty-two cables in the example shown, although the connector assembly 10 can be modified for use with other numbers of cables in the cable bundle 30. Each cable in the cable bundle 30 can be embodied as a twinaxial or twinax cable, in one example, including a pair of signal conductors insulated by a central dielectric insulating material and one or more drain or common conductors, suitable for short-range, high-speed differential data signaling applications. The cable bundle 30 can include other types of cables in other examples, however.

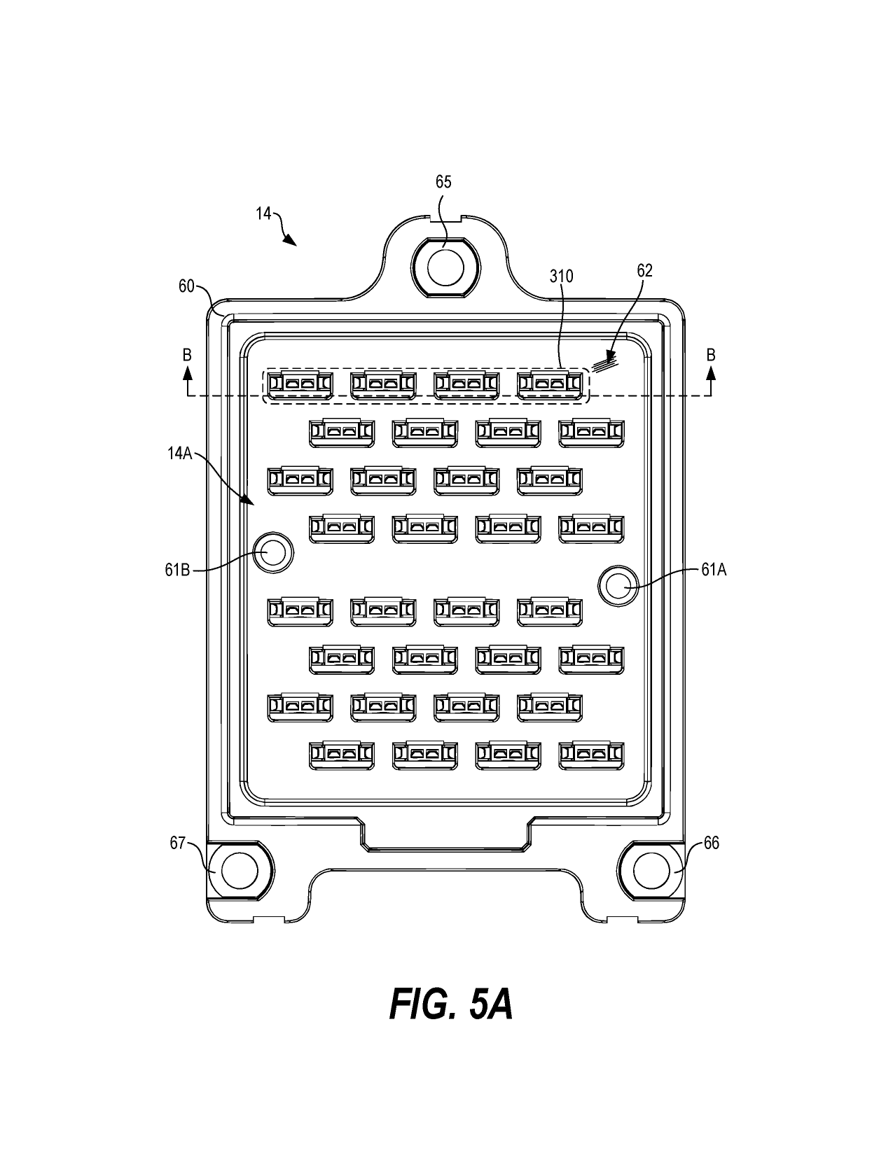

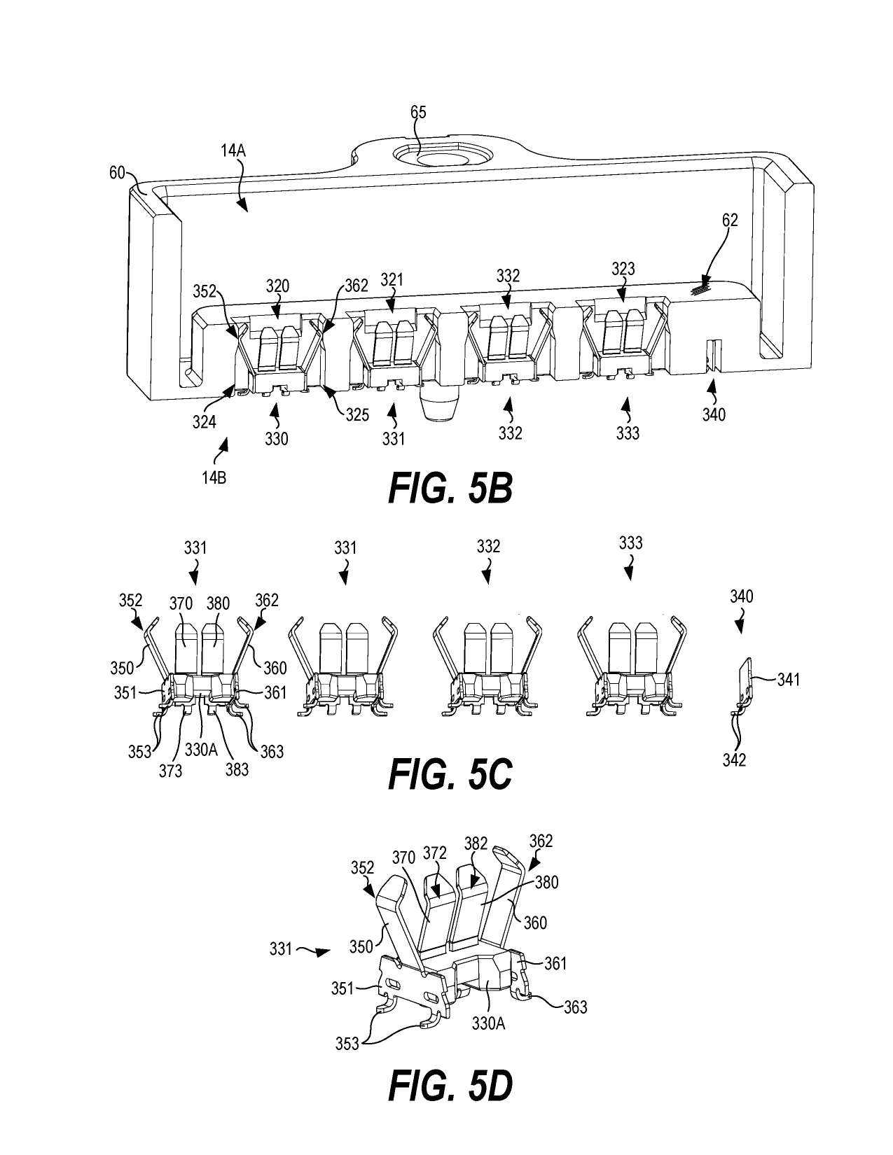

The socket connector 14 can be surface mounted to a PCB. The socket connector 14 includes a number of signal chicklet and shield terminal assemblies in the socket housing 60. Contact tail ends of the signal chicklet and shield terminal assemblies in the socket connector 14 extend down and form surface mount (SMT) contact tail ends at the surface mating interface 14B of the socket connector 14. The contacts tail ends can be surface mounted and electrically connected (e.g., soldered, sintered, etc.) to contact pads of a PCB. The contacts tail ends are arranged in rows 71-78. The rows 71-78 are staggered or offset with respect to each other in the longitudinal direction “L” in which the rows 71-78 extend. Particularly, the rows 71, 73, 75, and 77 are staggered apart from the rows 72, 74, 76, and 78 in the example shown, and other staggered arrangements can be relied upon. The staggered arrangement can help to reduce signal crosstalk in the socket connector 14. Additional aspects of the socket connector 14 are described below with reference to FIGS. 5A-5C.

FIG. 1C illustrates a perspective view of the plug connector 12 separated from the socket connector 14. As shown in FIG. 1C, the plug housing 20 of the plug connector 12 includes an insert region 20A and a body region 20B. The insert region 20A of the plug housing 20 can be inserted into a socket mating interface 14A of the socket connector 14, to connect the plug connector 12 with the socket connector 14.

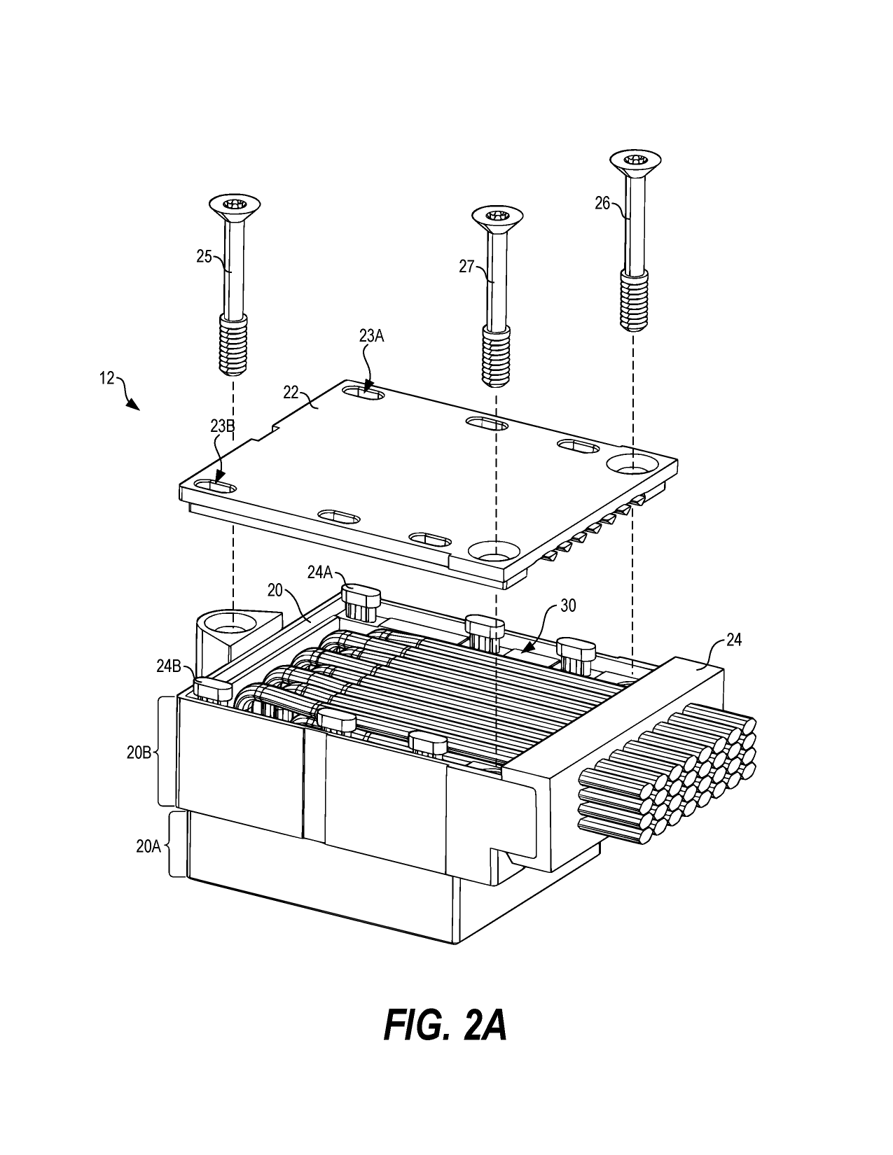

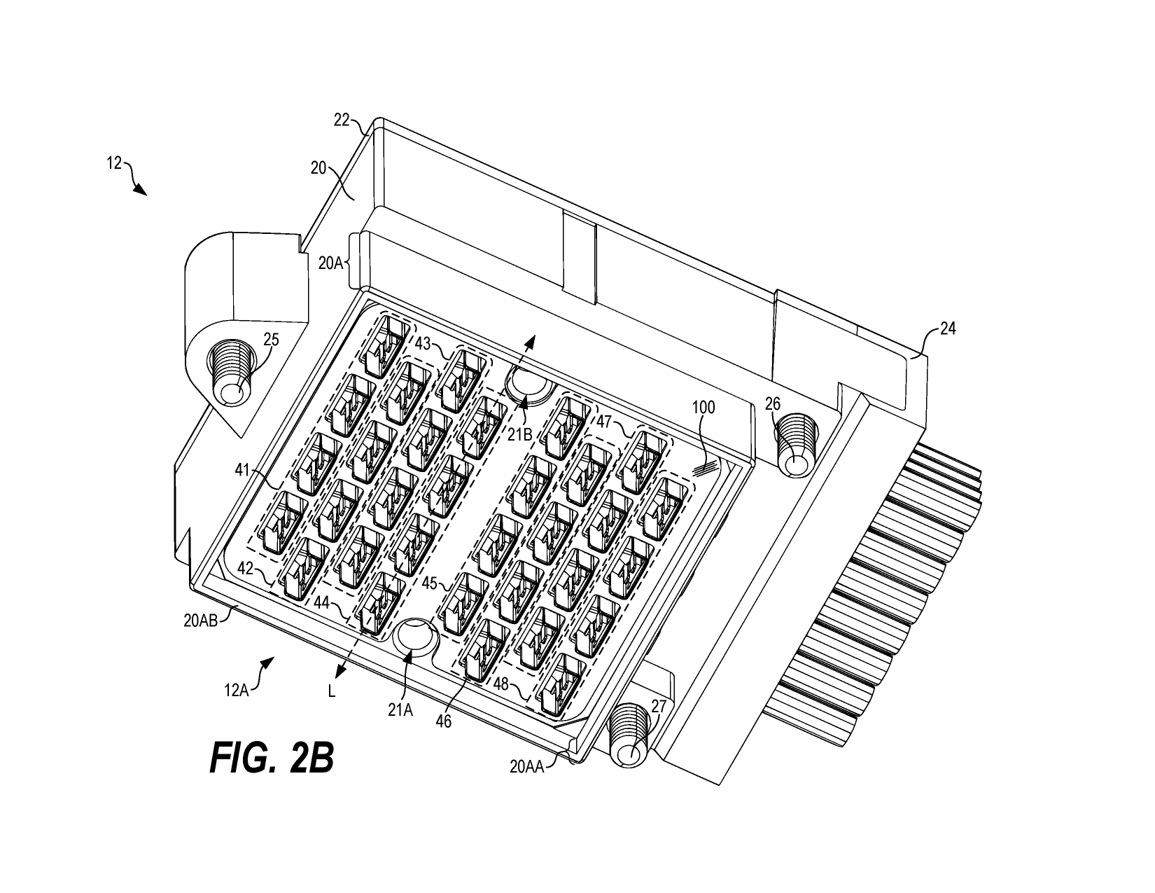

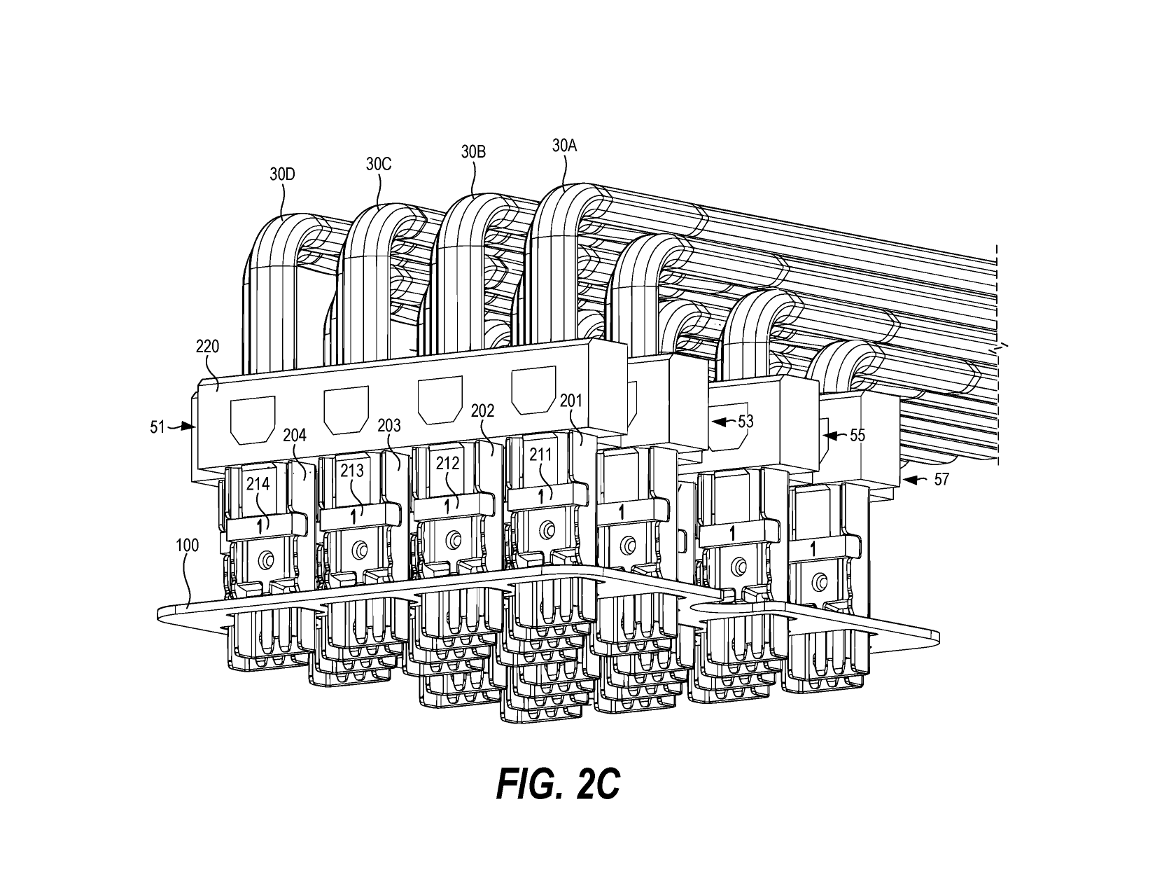

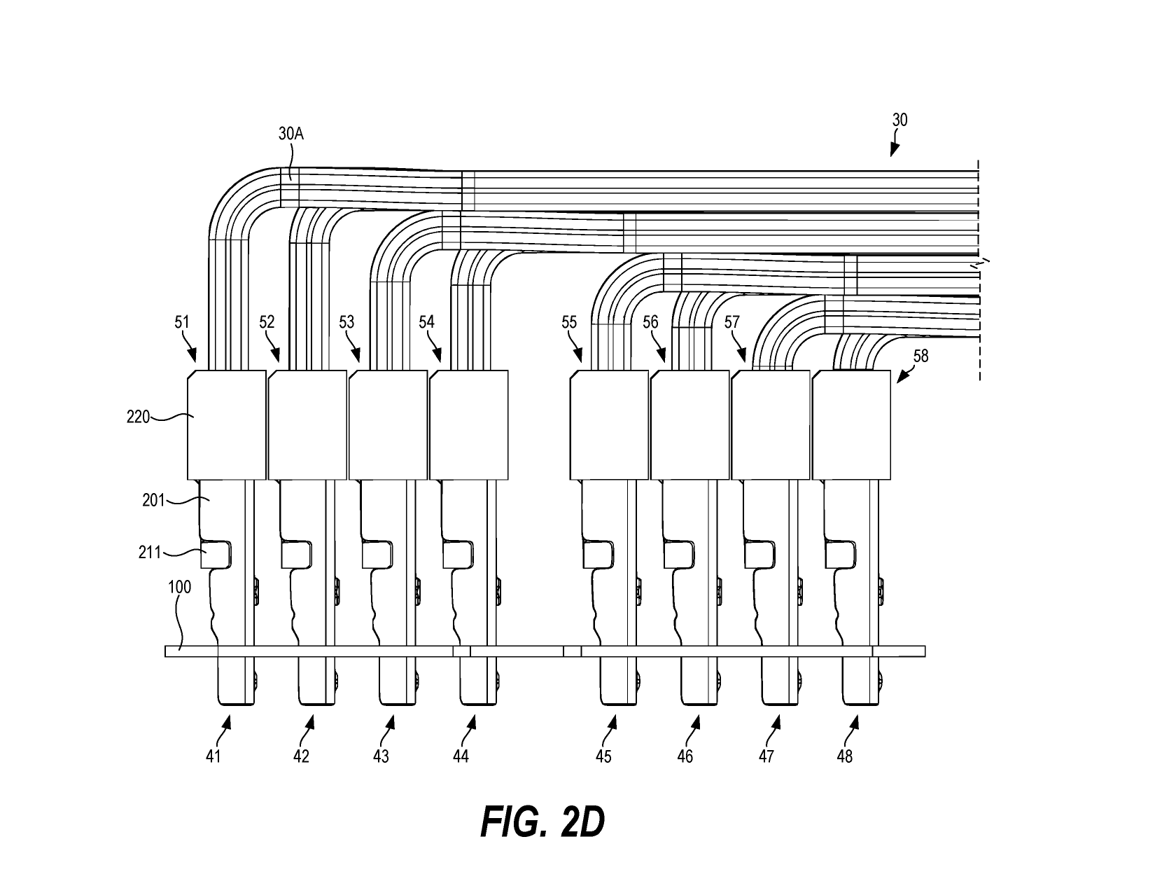

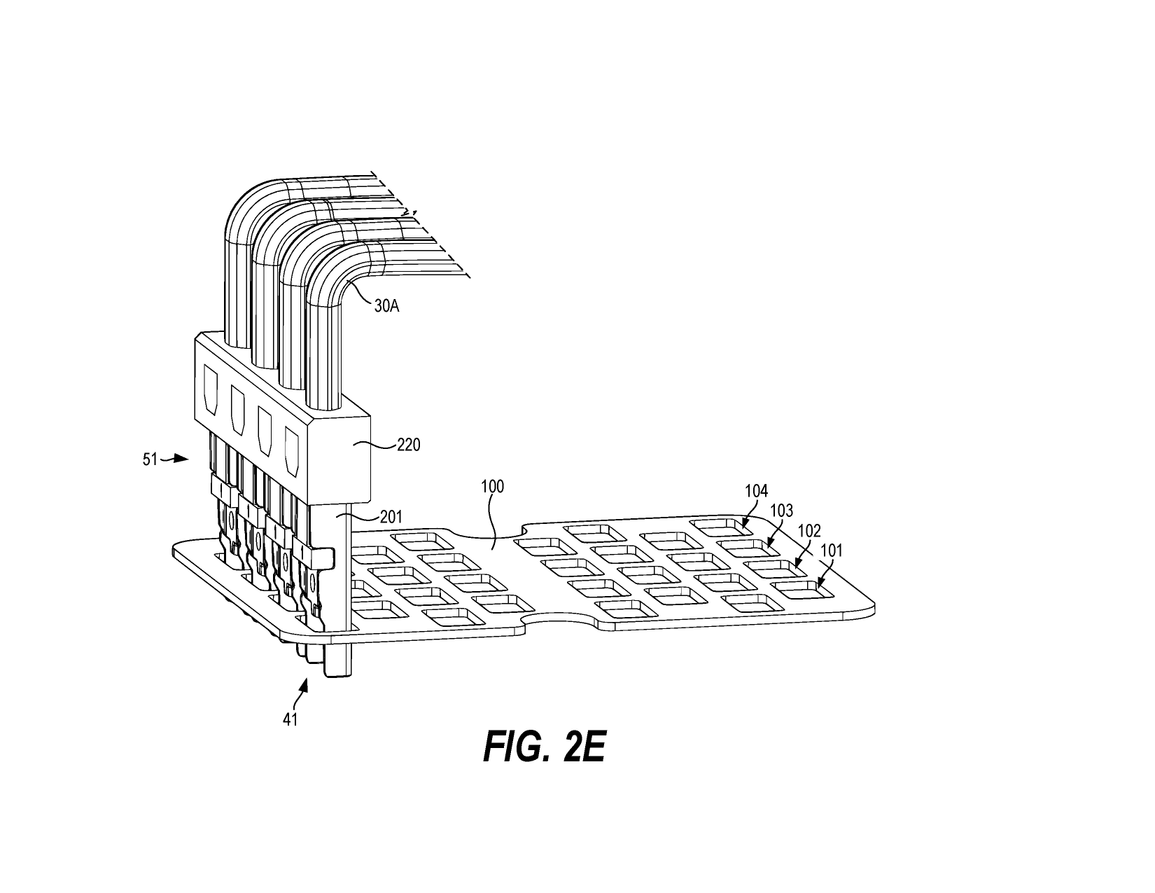

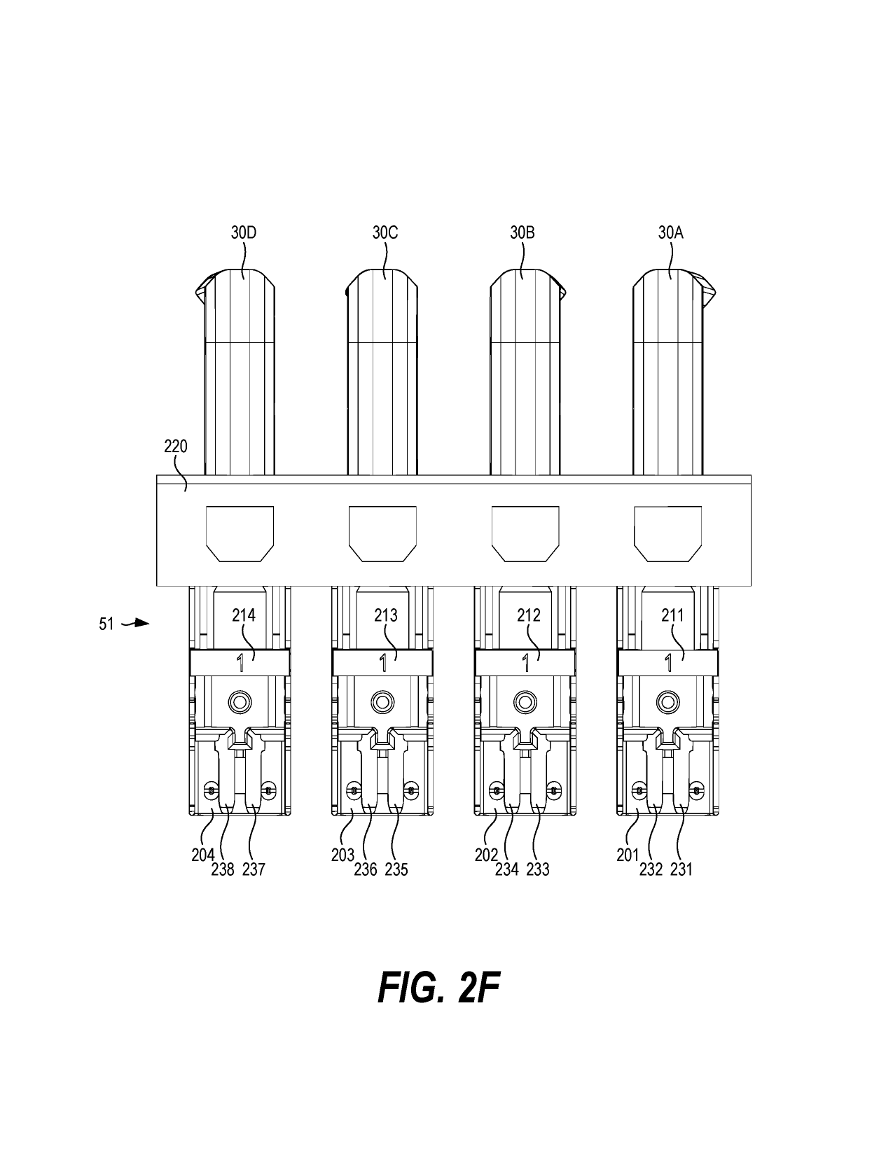

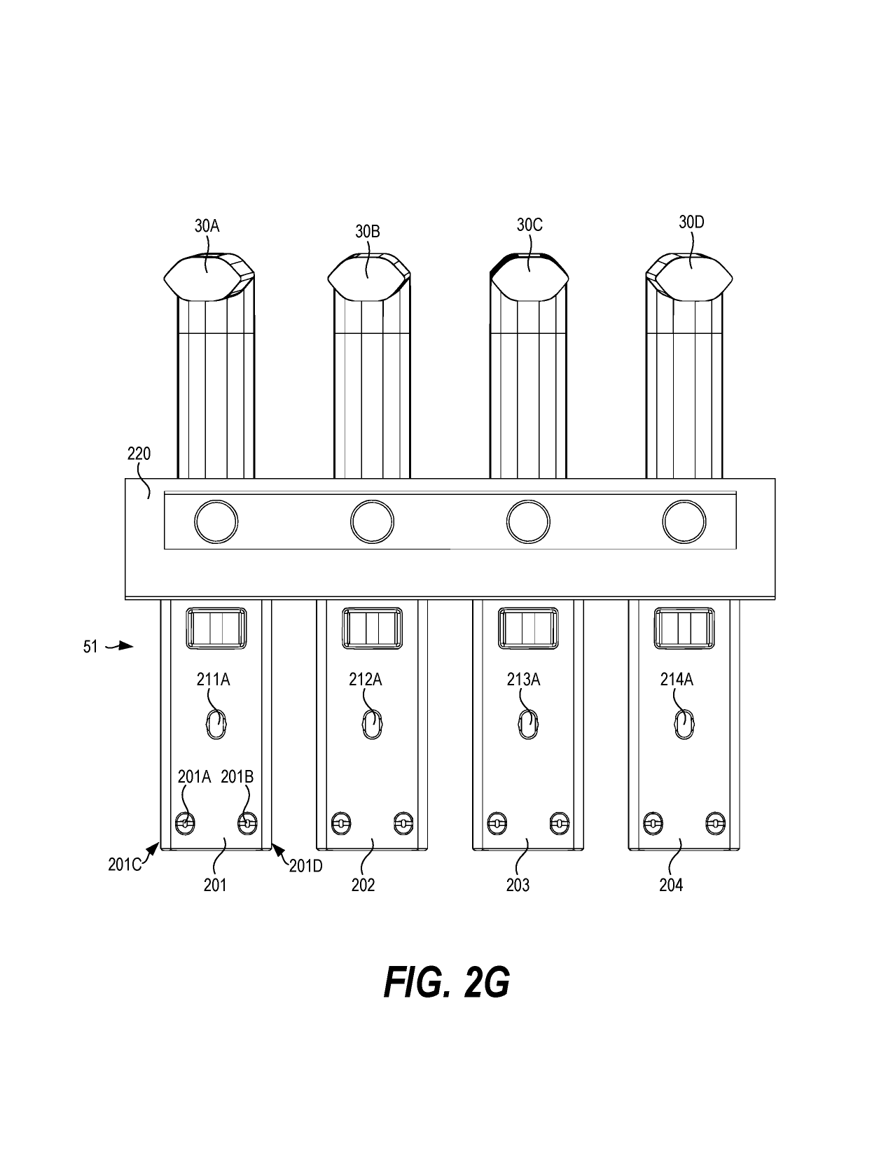

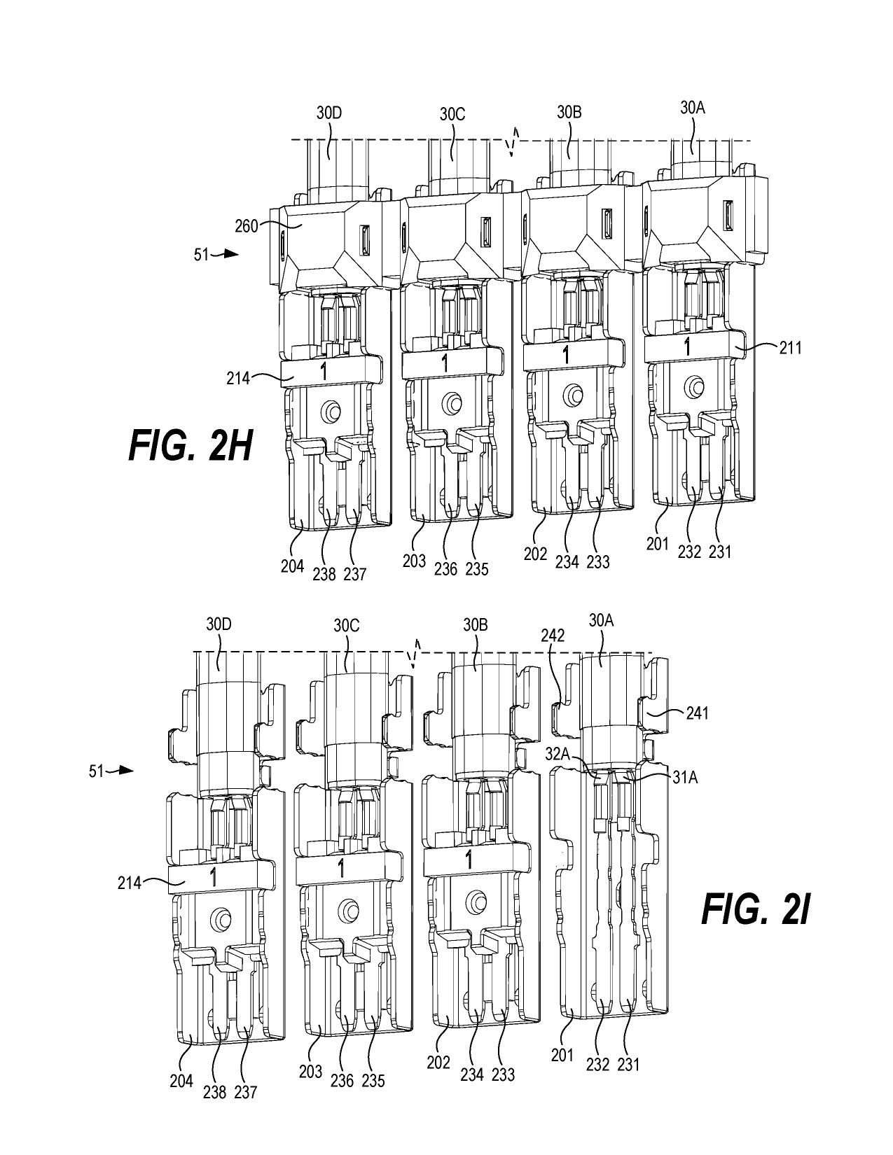

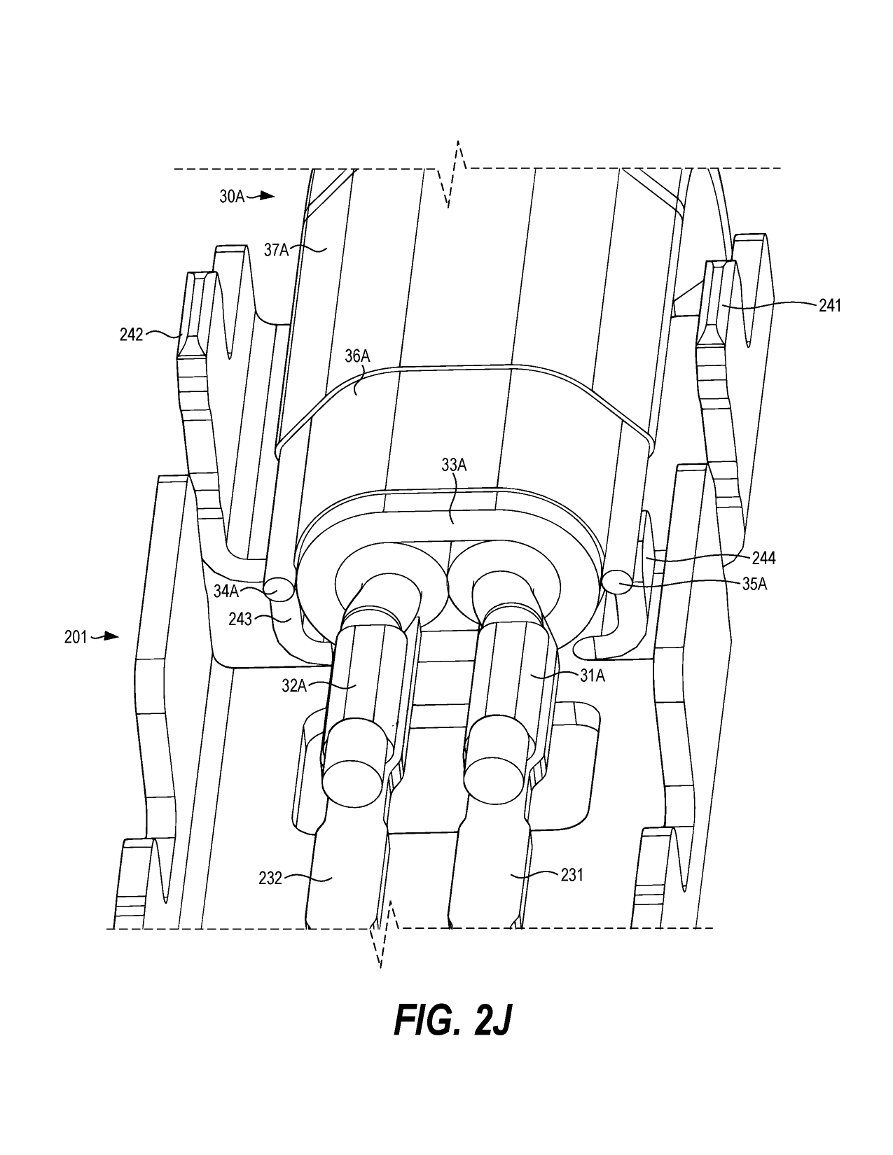

The plug connector 12 includes a number of wafer assemblies secured within the plug housing 20. The wafer assemblies are described in further detail below with reference to FIGS. 2C-2I. Signal and drain conductors of the cables in the cable bundle 30 are terminated, at one distal end, at the wafer assemblies within the plug housing 20. Contact ends of the wafer assemblies mate and electrically connect, respectively, with the signal chicklet and shield terminal assemblies in the socket connector 14. The signal chicklet and shield terminal assemblies of the socket connector 14 are described in further detail below with reference to FIGS. 5B and 5C. At the surface mating interface 14B of the socket connector 14, the contact tail ends of the signal chicklet and shield terminal assemblies can be surface mounted and electrically connected to contact pads of a PCB. Thus, the connector assembly 10 facilitates the electrical coupling or connection of data signals carried over the cables in the cable bundle 30 to signal traces on a PCB. The connector assembly 10 also facilitates shielding of the data signals from the cables in the cable bundle 30 to the PCB. The connector assembly 10 includes a number of features to enhance the shielding for the data signals carried over the cables in the cable bundle 30, as described below.

The plug housing 20 can be formed from a plastic or polymer, such as liquid crystal polymer (LCP), polyethylene (PE), polytetrafluoroethylene (PTFE), fluoropolymer, or other plastic or insulating material(s). The plug housing 20 can be formed using any suitable additive or subtractive manufacturing techniques, including molding, injection molding, printing, and other techniques. The outer surfaces of the plug housing 20 can be plated with a plating metal or metals for conductivity, and the plug housing 20 can be embodied as a plated plastic component. The surfaces can be etched in some cases and metalized or plated in a bath, barrel plated, plated by physical vapor deposition (PVD), plated by electroless plating, electroplating, sputter plating, ion plating, or other plating techniques or a combination thereof. The surfaces of the plug housing 20 can be metalized or plated with copper, nickel, tin, silver, another other plating metal, or a combination of such plating metals. Channel shields in the wafer assemblies within the plug housing 20 contact and are electrically coupled with the plug housing 20, and the plug housing 20 provides a common drain or ground connection for the plug connector 12, as described in further detail below.

The plug housing cover 22 can also be formed as a plated plastic component, similar to the plug housing 20. The plug housing cover 22 can be formed from a plastic or polymer, such as LCP, PE, PTFE, fluoropolymer, or other plastic or insulating material(s) and can be metalized or plated with metal or a combination of plating metals in some cases. The plug housing cover 22 can be secured over the plug housing 20 using an interference fit between housing posts of the plug housing 20 and positioning apertures of the plug housing cover 22, as described below with reference to FIG. 2A. The plug housing cover 22 can also be secured over the plug housing 20 using one or more of the plug anchors 25-27.

The cable bundle anchor 24 can also be formed from a plastic or polymer, such as LCP, PE, PTFE, fluoropolymer, or other plastic or insulating material(s) and can be metalized or plated with metal or a combination of plating metals in some cases. The cables in the cable bundle 30 extend through the cable bundle anchor 24. In some cases, the cable bundle anchor 24 can be molded around the cables in the cable bundle 30, to provide strain relief, although the cables can be inserted through the cable bundle anchor 24 in other cases. The cable bundle anchor 24 can be secured to the plug housing 20 using an interference fit, an adhesive, through plastic welding, other means, or combinations thereof.

Similar to the plug housing 20, the socket housing 60 of the socket connector 14 can be formed from a plastic or polymer, such as LCP, PE, PTFE, fluoropolymer, or other plastic or insulating material(s). The socket housing 60 can be formed using any suitable additive or subtractive manufacturing techniques, including molding, injection molding, printing, and other techniques. The outer surfaces of the socket housing 60 can be plated with a plating metal or metals for conductivity, and the socket housing 60 can be embodied as a plated plastic component. The surfaces can be etched in some cases and metalized or plated in a bath, barrel plated, plated by PVD, plated by electroless plating, electroplating, sputter plating, ion plating, or other plating techniques or a combination thereof. The surfaces of the socket housing 60 can be metalized or plated with copper, nickel, tin, silver, another other plating metal, or a combination of such plating metals. The socket housing 60 provides a common drain or ground connection for the socket connector 14, as described in further detail below.

The plug anchors 25-27 can be embodied as metal or plastic screws. The plug anchors 25-27 extend through apertures in the plug housing 20, through apertures in the plug housing cover 22, or through corresponding apertures in both the plug housing 20 and the plug housing cover 22, as shown in FIGS. 1A-1C. The plug anchors 25-27 can be any suitable size and style of screw, including screws with torx, star, phillips, pin, or other head ends with any suitable style of threading (e.g., angle, pitch, and lead tread style). The head ends of the plug anchors 25-27 have recessed flat torx heads in the example shown, although other types of anchors can be relied upon.

The socket anchors 65-67 can be embodied as metal or plastic barrel sockets, with threaded apertures extending into the barrel sockets. The barrel sockets of the socket anchors 65-67 can be inserted into barrel seats formed in the socket housing 60, as best shown in FIG. 1C, and secured in place using an interference fit. The socket anchors 65-67 include socket posts 65A-67A extending down from the barrels of the socket anchors 65-67 and through apertures in the socket housing 60. The socket posts 65A-67A extend down from a bottom surface of the socket housing 60 (see FIG. 1B) in the surface mating interface 14B region of the socket housing 60. Each of the socket posts 65A-67A can be inserted into plated apertures of a PCB, for example, and soldered in place, when the surface mating interface 14B region of the connector 10 is secured upon and electrically coupled to the PCB. The socket posts 65A-67A can be secured to a PCB in other ways, however, such as by using mechanical fasteners (i.e., pins, bolts, clips, etc.) in some cases. The socket posts 65A-67A provide mechanical support to the socket connector 14 and help to reduce stress on the signal and shield tail contact ends of the socket connector 14. The plug anchors 25-27 can be inserted and screwed into the threaded apertures within the barrel sockets of the socket anchors 65-67 when the plug connector 12 is connected with the socket connector 14.

FIG. 2A illustrates a top perspective view of the plug connector 12 shown in FIGS. 1A-1C with the plug housing cover 22 separated from the plug housing 20. The cable bundle 30 is shown extending within the body region 20B of the plug housing 20. The plug housing 20 includes housing posts at the top of the plug housing 20, including the housing posts 24A and 24B, among others. The plug housing cover 22 includes positioning apertures, including the positioning apertures 23A and 23B, among others. The plug housing cover 22 can be secured over the plug housing 20 using an interference fit between the housing posts 24A and 24B of the plug housing 20 and the positioning apertures 23A and 23B of the plug housing cover 22. The plug housing cover 22 can also be secured over the plug housing 20 using the plug anchors 26 and 27.

FIG. 2B illustrates a bottom perspective view and a mating interface 12A of the plug connector 12 shown in FIGS. 1A-1C. The insert region 20A of the plug housing 20 includes an insert recess 20AA. The insert recess 20AA is recessed back towards the center of the plug housing 20 from the bottom peripheral edge 20AB of the insert region 20A. Contact ends of the wafer assemblies in the plug connector 12 extend through apertures or openings in the insert region 20A of the plug housing 20, as shown in FIG. 2B, forming rows 41-48 of wafer assembly contact ends. Four contact ends of a single wafer assembly of the plug connector 12 extend through the plug housing 20 to form one of the rows 41-48. The rows 41-48 are staggered or offset with respect to each other in the longitudinal direction “L” in which the rows 41-48 extend. Particularly, the rows 41, 43, 45, and 47 are staggered apart from the rows 42, 44, 46, and 48 in the example shown, and other staggered arrangements can be relied upon. The staggered arrangement can help to reduce signal crosstalk between the signals on two different wafer assemblies.

The rows 41-44 can include contacts for data reception, and the rows 45-48 can include contacts for data transmission. Alternatively, the rows 41-44 can include contacts for data transmission, and the rows 45-48 can include contacts for data reception. Thus, in the plug connector 12, the contacts for data reception and transmission can be separated from each other within the insert region 20A of the plug housing 20. As shown in FIG. 2A, the spacing between the group of rows 41-44 and the group of rows 45-48 is greater than the individual spacing between any two of the rows 41-44 or any two of the rows 45-48. The separation between the rows 41-44 and the rows 45-48 can help to reduce signal crosstalk between the signals for data reception and transmission in the plug connector 12.

The plug connector 12 also includes a conductive elastomeric gasket 100 (also “conductive gasket 100”). The conductive gasket 100 is secured to an outer surface of the plug housing 20. In the example shown in FIG. 2B, the conductive gasket 100 is positioned on an outer surface of the plug housing 20 in a region of the mating interface 12A of plug connector 12, particularly on a surface within the insert region 20A of the plug housing 20. The contact ends of the wafer assemblies in the plug connector 12 extend through apertures or openings in the conductive elastomeric gasket 100, as also shown in FIGS. 2D and 2E. The conductive gasket 100 can be formed from a conductive elastomeric or foam material. The conductive gasket 100 is elastic and compressible to some extent. As one example, the conductive gasket 100 can be embodied as a polyurethane foam multi-laminate including conductive materials, such as copper, nickel, or other conductive metals or materials disposed therein. In one particular example, the conductive gasket 100 can be embodied as the P-SHIELD® brand PS-1323 conductive foam or conductive foam tape or sheet manufactured by Polymer Science, Inc. of Monticello, Indiana, although other suitable types of conductive elastomeric or foam materials can be relied upon. The conductive gasket 100 can range in thickness from between 0.1-3 mm, and example thicknesses include 0.5 mm, 1.0 mm, 1.5 mm, 2.0 mm, 2.5 mm, 2.5 mm, and 3.0 mm, although other thicknesses can be relied upon. A conductive adhesive can be applied between one surface of the conductive gasket 100 and a surface within the insert region 20A of the plug housing 20, to secure the conductive gasket 100 to the plug housing 20.

In some cases, the socket connector 14 can also include a conductive gasket similar to the conductive gasket 100. For example, referring back to FIG. 1C, a conductive gasket can be placed over the surface 62 of the socket housing 60 within the socket mating interface 14A of the socket connector 14. In other cases, the conductive gasket 100 of the plug connector 12 can be omitted, and the socket connector 14 can include a conductive gasket over the surface 62 of the socket housing 60.

Due to its elastomeric properties, the conductive gasket 100 can be compressed against a surface of the socket housing 60, making continuous contact with it, even if the entire surface does not extend in the exact same plane. Particularly, the conductive gasket 100 can contact the surface 62 of the socket housing 60 within the socket mating interface 14A, as shown in FIG. 1C. The conductive gasket 100 can help to electrically couple the plug connector 12 with the socket connector 14. The conductive gasket 100 can achieve better contact with surfaces, such as the surface 62, particularly if the surface is even slightly irregular due to manufacturing tolerances. The enhanced shielding provided by the conductive gasket 100 helps to maintain signal integrity and higher data throughput for the connector assembly 10. The conductive properties of the conductive gasket 100 also help to electrically couple and common the potentials among the channel shields 201-204.

FIG. 2C illustrates a perspective view of the plug connector 12 shown in FIGS. 1A-1C, with parts omitted. FIG. 2D illustrates a side view of the plug connector 12 shown in FIGS. 1A-1C, with parts omitted. Particularly, the plug housing 20, plug housing cover 22, plug anchors 25-27, and cable bundle anchor 24 are omitted from view in FIGS. 2C and 2D. Referring between FIGS. 2C and 2D, the plug housing 20 includes eight wafer assemblies 51-58. The wafer assemblies 51-58 are illustrated as representative examples and are not drawn to any particular scale or size. The shape, size, proportion, and other characteristics of the wafer assemblies 51-58 can vary as compared to that shown in other embodiments. The plug connector 12 includes eight wafer assemblies 51-58 in the example shown. The plug connector 12 can include other numbers of wafer assemblies in other cases, however, including fewer or greater numbers of wafer assemblies. Each of the wafer assemblies 51-58 includes similar components and can be formed and structured in the same way. Thus, while the components of the wafer assembly 51 are described in detail below, each of the wafer assemblies 52-58 can include the same components and structure as the wafer assembly 51.

The wafer assemblies 51-58 are staggered or offset with respect to each other in within the plug housing 20. Particularly, the wafer assemblies 51, 53, 55, and 57 are staggered apart from the wafer assemblies 52, 54, 56, and 58 in the example shown, and other staggered arrangements can be relied upon. The staggered arrangement can help to reduce signal crosstalk in the plug connector 12.

Four cables among the cable bundle 30 are terminated to each of the wafer assemblies 51-58. For example, the cables 30A-30D are terminated at and to the wafer assembly 51. Each of the wafer assemblies 51-58 includes four pairs of signal conductors and four channel shields. Each pair of signal conductors extends within a channel of a respective channel shield, and the channel shield provides a common ground and shield for the pair of signal conductors. Each of the wafer assemblies 51-58 also includes a conductive cable clamp, a wafer overmold, and a number of conductor inserts. These and other aspects of the wafer assemblies 51-58 are described in further detail below.

Referring to FIG. 2C, the wafer assembly 51 includes channel shields 201-204. The channel shields 201-204 are common or ground shields in the wafer assembly 51. The channel shields 201-204 are formed as U-shaped shields in the examples described herein, although the channel shields 201-204 can be formed in other shapes. The channel shields 201-204 can be separately formed from (e.g., stamped, sheared, or otherwise formed out of) a flat sheet of metal material. Drain conductors of the cables 30A-30D are electrically connected to the channel shields 201-204, respectively, as described below with reference to FIG. 2J. Signal terminal inserts 211-214 are positioned within the channels of the channel shields 201-204, respectively. The conductor inserts 211-214 surround and electrically isolate signal terminals that extend within the channel shields 201-204. A conductive cable clamp is secured and electrically coupled to and among the channel shields 201-204, under the wafer overmold 220. The conductive cable clamp is described below with reference to FIGS. 2H-2K.

FIG. 2E illustrates a side view of the wafer assembly 51 and the conductive gasket 100 in the plug connector 12. The conductive gasket 100 includes a number of apertures, including the apertures 101-104, among others. The contact ends of the wafer assemblies in the plug connector 12 extend through the apertures or openings in the conductive gasket 100. For example, the contact ends of the wafer assembly 51 extend through apertures in the conductive gasket 100, as shown in FIG. 2E, and FIG. 2D shows how each of the wafer assemblies 51-58 extend through the conductive gasket 100.

FIG. 2F illustrates a front view of the wafer assembly 51 in the plug connector 12 shown in FIGS. 1A-1C. The wafer assembly 51 includes the channel shields 201-204 and signal terminal inserts 211-214 positioned within the channels of the channel shields 201-204, respectively. The signal terminal inserts 211-214 surround and electrically isolate signal terminals that extend within the channel shields 201-204. Particularly, the signal terminal insert 211 surrounds and isolates signal terminals 231 and 232, the signal terminal insert 212 surrounds and isolates signal terminals 233 and 234, the signal terminal insert 213 surrounds and isolates signal terminals 235 and 236, and the signal terminal insert 214 surrounds and isolates signal terminals 237 and 238. The signal terminal inserts 211-214 surround and electrically isolate the signal terminals 231-218 from the conductive surfaces of the channel shields 201-204.

The signal terminals 231-238 can be formed from (e.g., stamped, sheared, or otherwise formed out of) a flat sheet of metal, such as a lead frame. In some cases, the sheet of metal or lead frame can be plated with one or more plating metals. The signal terminal inserts 211-214 can be formed from a plastic or polymer, such as LCP, PE, PTFE, fluoropolymer, or other plastic or insulating material(s). The signal terminal inserts 211-214 can be molded around the lead frame from which the signal terminals 231-238 are formed, before the signal terminals 231-238 are separated from the larger lead frame. The channel shields 201-204 can also be positioned around the signal terminal inserts 211-214, respectively, before the signal terminal inserts 211-214 and signal terminals 231-238 are separated from the lead frame. When the signal terminal inserts 211-214 are molded around the signal terminal inserts 211-214, the signal terminal inserts 211-214 can be formed to include staking posts. The staking posts are used to secure the signal terminal inserts 211-214 and the signal terminal inserts 211-214 to the channel shields 201-204 during a heat staking process described below. The signal terminal inserts 211-214 secure and position the signal terminals 231-238 with respect to each other and with respect to the channel shields 201-204. The signal terminal inserts 211-214 maintain the positions and spacings of the signal terminals 231-238 within the channels of the channel shields 201-204.

The channel shields 201-204 are common or ground shields in the plug connector 12 and, along with the conductive cable clamps in the wafer assemblies 51-58, the plug housing 20, the conductive gasket 100, and possibly the plug housing cover 22, form a common shield or ground network for the plug connector 12. The channel shields 201-204 are formed as U-shaped shields in the examples described herein, although the channel shields 201-204 can be formed in other shapes.

Signal conductors in the cables 30A-30D are electrically coupled to the signal terminals 231-238 in the wafer assembly 51. As noted above, each cable in the cable bundle 30 can be embodied as a twinaxial or twinax cable, including a pair of signal conductors insulated by a central dielectric insulating material and one or more drain or common conductors. The pair of signal conductors in the cable 30A are electrically coupled, respectively to the signal terminals 231 and 232, the pair of signal conductors in the cable 30B are electrically coupled, respectively to the signal terminals 233 and 234, the pair of signal conductors in the cable 30C are electrically coupled, respectively to the signal terminals 235 and 236, and the pair of signal conductors in the cable 30D are electrically coupled, respectively to the signal terminals 237 and 238.

FIG. 2G illustrates a back view of the wafer assembly 51 in the plug connector 12 shown in FIGS. 1A-1C. Staking caps 211A-214A of the signal terminal inserts 211-214 are shown at the back sides of the channel shields 201-204 in FIG. 2G. When the signal terminal inserts 211-214 are molded around the signal terminal inserts 211-214, the signal terminal inserts 211-214 can be formed to include staking posts. The staking posts extend through openings in the channel shields 201-204 and are heat staked to form the staking caps 211A-214A. The staking caps 211A-214A help to secure the signal terminal inserts 211-214 within the channel shields 201-204. The staking caps 211A-214A can also be formed to align the wafer assembly 51, and particularly the channel shields 201-204, within apertures or openings within the plug housing 20.

The channel shields 201-204 also include contact dimples. For example, the channel shield 201 includes contact dimples 201A and 201B, and each of the channel shields 202-204 includes similar contact dimples. The contact dimples 201A and 201B have a raised profile from the back surface of the channel shield 201 and make contact with an inner surface of an aperture in the socket housing 60 of the socket connector 14, when the plug connector 12 is connected with the socket connector 14. Thus, the contact dimples on the channel shields 202-204 help to electrically couple the common shield or ground network of the plug connector 12 to the common shield or ground network of the socket connector 14. Sidewalls 201C and 201D of the channel shield 201 also make contact with inner surfaces of an aperture in the plug housing 20, making further contact with the plug housing 20. Side surfaces of the channel shields 202-204 also make contact with inner surfaces of other apertures in the plug housing 20.

FIG. 2H illustrates the wafer assembly 51 with the wafer overmold 220 omitted from view. With the wafer overmold 220 omitted, a conductive cable clamp 260 (also “cable clamp 260”) of the wafer assembly 51 is visible. In one example, the conductive cable clamp 260 can be formed separately from a plastic or polymer, such as LCP, PE, PTFE, fluoropolymer, or other plastic or insulating material(s). The conductive cable clamp 260 can be formed using any suitable additive or subtractive manufacturing techniques, including molding, injection molding, printing, and other techniques. The outer surfaces of the conductive cable clamp 260 can be plated with a plating metal or metals for conductivity, and the conductive cable clamp 260 can be embodied as a plated plastic component. The surfaces can be etched in some cases and metalized or plated in a bath, barrel plated, plated by PVD, plated by electroless plating, electroplating, sputter plating, ion plating, or other plating techniques or a combination thereof. The surfaces of the conductive cable clamp 260 can be metalized or plated with copper, nickel, tin, silver, another other plating metal, or a combination of such plating metals. In another example, the conductive cable clamp 260 can be formed of a conductive material, such as a metal or metal alloy, by casting or other additive or subtractive processing techniques.

The conductive cable clamp 260 is positioned over and secured to each of the channel shields 201-204 in the position shown in FIG. 2H. The conductive cable clamp 260 provides an electrical connection among the channel shields 201-204, to form a common ground among them. The conductive cable clamp 260 helps to provide a common shield or ground network for the wafer assembly 51, as it electrically couples the channel shields 201-204 together.

FIG. 2I illustrates the wafer assembly 51 with the conductive cable clamp 260 and the signal terminal insert 211 omitted. As shown in FIG. 2I, the cable 30A includes a pair of signal conductors 31A and 32B. The signal conductors 31A and 32B are electrically coupled (e.g., welded, soldered, etc.) to the signal terminals 231 and 232, respectively. Signal conductors in the cables 30B-30D are electrically coupled to the signal terminals 233-238 in a similar way. Drain conductors of the cables 30A-30D are also electrically coupled to the channel shields 201-204, respectively, as described below with reference to FIG. 2J.

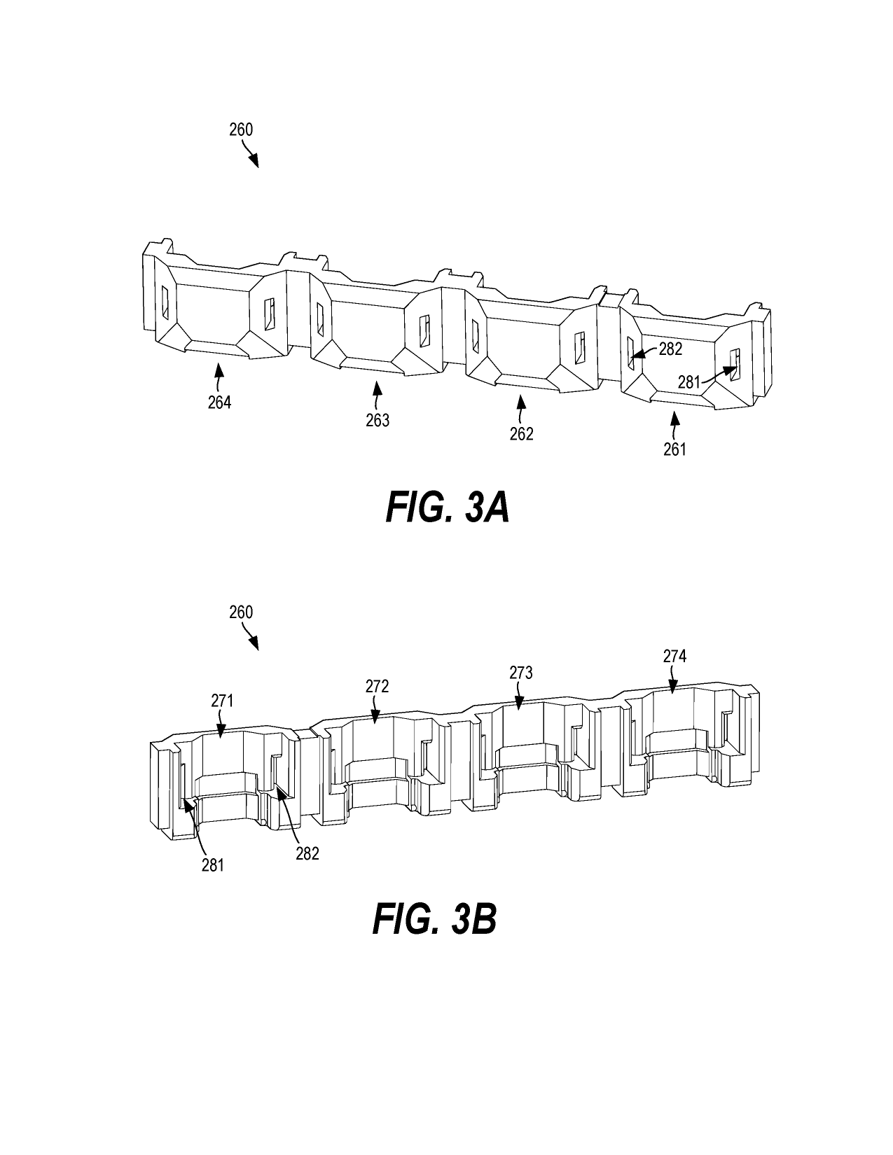

As also shown in FIG. 2I, each of the channel shields 201-204 includes insert tabs. For example, the channel shield 201 includes insert tabs 241 and 242, and each of the channel shields 202-204 includes similar insert tabs. The conductive cable clamp 260 includes slit channels, which are described below with reference to FIGS. 3A and 3B. The conductive cable clamp 260 can be positioned over the channel shields 201-204 and the cables 30A-30D with the insert tabs of the channel shields 201-204 extending into the slit channels. The insert tabs of the channel shields 201-204 provide an interference fit with the conductive cable clamp 260, to secure and electrically connect the conductive cable clamp 260 with the channel shields 201-204. The conductive cable clamp 260 also provides some strain relief between the cables 30A-30D and the channel shields 201-204 in the wafer assembly 51. After the conductive cable clamp 260 is positioned as shown in FIG. 2H, the wafer overmold 220 (see FIGS. 2F and 2G) can be molded around the conductive cable clamp 260. The wafer overmold 220 can be a molded plastic or polymer and, in some cases, be metalized or plated with one or more plating metals. The wafer overmold 220 provides strain relief between the cables 30A-30D and the channel shields 201-204 in the wafer assembly 51.

FIG. 2J illustrates a channel shield 201 and cable 30A of the wafer assembly 51. The cable 30A includes the signal conductors 31A and 32B, a dielectric material 33A surrounding the signal conductors 31A and 32B, a foil or shield layer 36A, drain conductors 34A and 35B, and an outer jacket 37A. The outer jacket 37A of the cable 30A is stripped or cut back to expose the drain conductors 34A and 35B. The channel shield 201 includes drain tabs 243 and 244 that extend up from the body of the channel shield 201, and the cable 30A is positioned between the drain tabs 243 and 244 with the drain conductors 34A and 35B resting upon and contacting the top edges of the drain tabs 243 and 244. The drain conductors 34A and 35B are electrically coupled (e.g., welded, soldered, etc.) to the top edges of the drain tabs 243 and 244, respectively. The signal conductors 31A and 32B are also electrically coupled to the signal terminals 231 and 232, respectively.

FIG. 3A illustrates a front perspective view of the cable clamp 260 of the wafer assembly 51 shown in FIG. 2H, and FIG. 3B illustrates a back perspective view of the cable clamp 260. The cable clamp 260 is formed as a single integral piece and can be embodied as a plated plastic component, as described above. The cable clamp 260 includes a number of sections, including the clamp sections 261-264. Each of the clamp sections 261-264 is formed in a “C” shape, based on the outer profile shape of the cables 30A-30D. As shown in FIG. 3B, the clamp sections 261-264 include recess channels 271-274, respectively. When the wafer assembly 51 is assembled, the cables 30A-30D extend within the recess channel 271-274, and inner surfaces of the recess channels 271-274 contact outer surfaces of the cables 30A-30D, helping to secure the cables 30A-30D together with the channel shields 201-204.

Each of the clamp sections 261-264 includes slit channels. For example, the clamp section 261 includes slit channels 281 and 282, and the other clamp sections 262-264 include similar slit channels. The slit channels 281 and 282 are relatively narrow apertures through the clamp section 261. When the cable clamp 260 is positioned and fitted over the channel shields 201-204 and the cables 30A-30D as shown in FIG. 2H, insert tabs of the channel shields 201-204 extend into the slit channels of the cable clamp 260. The insert tabs of the channel shields 201-204 provide an interference fit with the conductive cable clamp 260, to secure and electrically connect the cable clamp 260 with the channel shields 201-204. For example, the channel shield 201 includes insert tabs 241 and 242, as shown in FIG. 2J, and the insert tabs 241 and 242 fit into the slit channels 281 and 282, respectively, providing an interference fit between the cable clamp 260 and the channel shield 201. A similar interference fit is also provided between each of the channel shields 202-204 and the cable clamp 260.

Because the cable clamp 260 is a conductive component, it provides an electrical coupling among each of the channel shields 201-204. As each of the channel shields 201-204 is electrically coupled to the drain conductors in the cables 30A-30D, respectively, the cable clamp 260 electrically commons or ties the potentials among the channel shields 201-204 and the drain conductors in the cables 30A-30D together. The cable clamp 260 thus provides a common ground among each of the cables 30A-30D in the wafer assembly 51. The cable clamp 260 can help to reduce signal interference among the data signals carried on the wafer assembly 51, facilitating higher data throughput in the plug connector 12.

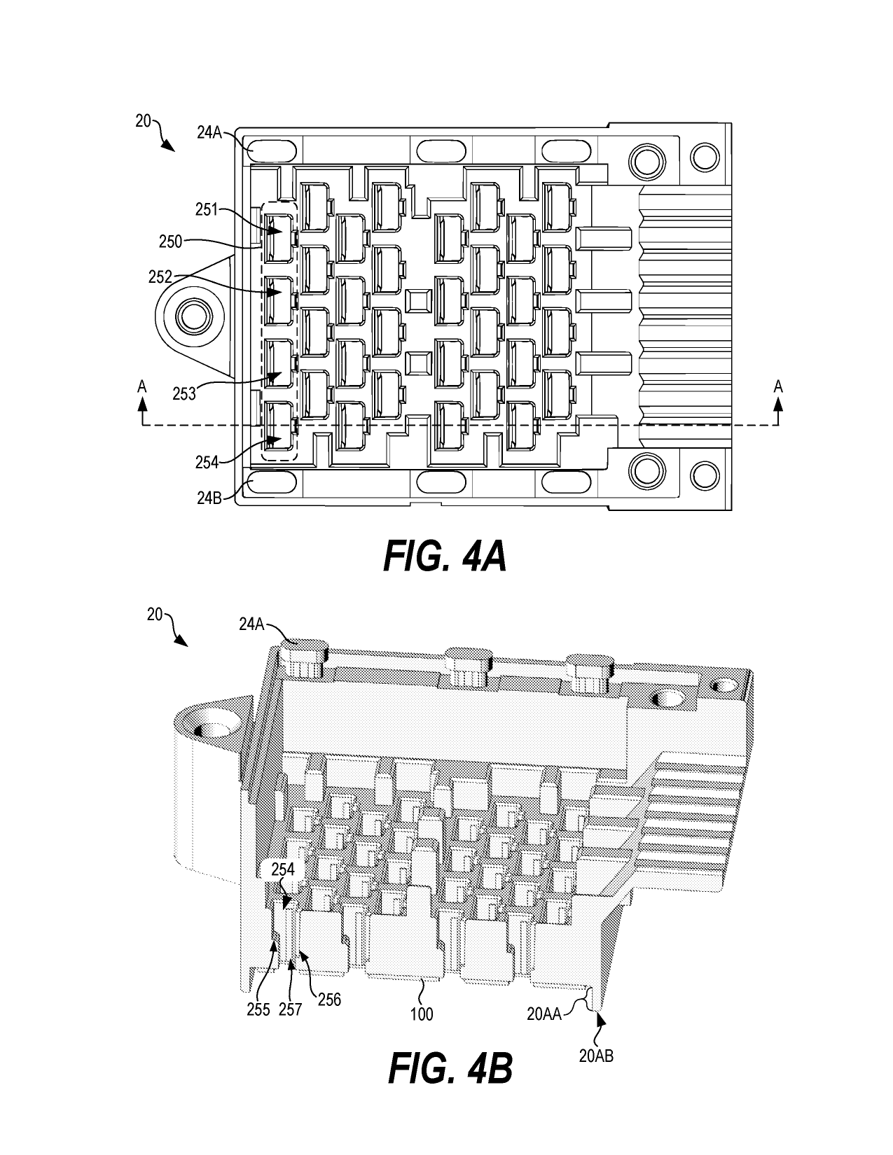

FIG. 4A illustrates a top view of the plug housing 20 of the plug connector 12. The plug housing 20 includes regions in which each of the wafer assemblies 51-58 can be seated and secured. For example, the wafer assembly 51 can be secured in the region 250 within the plug housing 20, and the wafer assemblies 52-58 can be secured in similar regions, in a side-by-side arrangement, within the plug housing 20. The plug housing 20 includes apertures 251-254 in the region 250. The channel shields 201-204 and signal terminals 231 and 232 extend through the apertures 251-254, to form the row 41 of contact ends (see FIG. 2B). The channel shields and signal terminals of the other wafers 52-58 extend through the other apertures in the plug housing 20, to form the rows 42-48 of contact ends. The outer surfaces of the channel shields 201-204 contact the inner surfaces of the apertures 251-254, making an electrical coupling or connection to the plug housing 20.

FIG. 4B illustrates the cross-sectional view designated A-A in FIG. 4A. In FIG. 4B, certain features within the aperture 254 are visible. For example, an interference ledge 255, a positioning channel 256, and an interference ridge 257 are shown within the aperture 254 in FIG. 4B. Each of the apertures in the plug housing 20 include features similar to those in the aperture 254. The interference ledge 255 forms a ledge or surface upon which the signal terminal insert 211 (see FIG. 2F) can seat and rest upon when the wafer assembly 51 is installed within the plug housing 20. The positioning channel 256 forms a channel in which the staking cap 211A (see FIG. 2G) of the signal terminal insert 211 can be inserted within. The positioning channel 256 in the aperture 254 and similar positioning channels in the other apertures 251-254 can guide the staking caps 211A-214A and, thus, the channel shields 201-204, into the apertures 251-254. The interference ridge 257 comprises a ridge of material that is raised off of the inner side surface of the aperture 254. The sidewall 201D of the channel shield 201 (see FIG. 2G) makes contact with (and is possibly compressed against) the interference ridge 257 within the aperture 254. The other sidewall 201C of the channel shield 201 makes contact with another interference ridge at the other inner side surface (not shown in FIG. 4B) within the aperture 254.

FIG. 5A illustrates a top view of the socket connector 14 shown in FIGS. 1A and 1B according to various aspects of the present disclosure. The socket mating interface 14A of the socket connector 14 is visible in FIG. 5A. The socket connector 14 includes a number of signal chicklet and shield terminal assemblies, which are described below with reference to FIGS. 5B and 5C. Contact lead ends of the signal chicklet and shield terminal assemblies are exposed and visible in the socket mating interface 14A of the socket connector 14. The contacts lead ends are arranged in rows. For example, the socket connector 14 includes a row 310 of contact lead ends, among other rows. The rows of contact leads are staggered or offset with respect to each other, which can help to reduce signal crosstalk in the socket connector 14.

The socket connector 14 includes a pair of offset keyposts 61A and 61B, which extend up from the surface 62 of the socket housing 60 within the socket mating interface 14A. Corresponding to the keyposts 61A and 61B, the plug housing 20 includes keyway apertures 21A and 21B, as shown in FIG. 2B. The keyposts 61A and 61B extend into the keyway apertures 21A and 21B, respectively, when the plug connector 12 is mated with the socket connector 14. The keyway apertures 21A and 21B and keyposts 61A and 61B are pitched or offset apart from any line of symmetry in the connector assembly 10. Thus, the keyposts 61A and 61B will interfere with housing 20 of the plug connector 12, if the plug connector 12 is not oriented with respect to the socket connector 14 in the arrangement shown in FIG. 1C. In some cases, the socket connector 14 can include a conductive gasket similar to the conductive gasket 100. For example, a conductive gasket can be placed over the surface 62 of the socket housing 60 within the socket mating interface 14A of the socket connector 14.

FIG. 5B illustrates the cross-sectional view designated B-B in FIG. 5A. As shown, the socket housing 60 includes a number of apertures, including the apertures 320-323. When the plug connector 12 is mated with the socket connector 14, the channel shields 201-204 and signal terminals 231-238 of the wafer assembly 51 will be inserted and extend into the apertures 320-323. Signal chicklet and shield terminal assemblies are positioned within the apertures. For example, the signal chicklet and shield terminal assemblies 330-333 (also “terminal assemblies 330-333”) are positioned and secured, respectively, within the apertures 320-323. Contact tail ends of the terminal assemblies 330-333 extend down and form SMT tails at the surface mating interface 14B of the socket connector 14. Contact lead ends of the terminal assemblies 330-333 extend up and are exposed at the socket mating interface 14A of the socket connector 14. When the plug connector 12 is mated with the socket connector 14, the channel shields 201-204 and signal terminals 231-238 of the wafer assembly 51 contact and are electrically coupled with the terminal assemblies 330-333, as described below.

FIG. 5C illustrates the terminal assemblies 330-333 in the socket connector 14 shown in FIG. 5B, and FIG. 5D illustrates another view of the terminal assembly 330. The terminal assembly 330 includes a base 330A, shield terminals 350 and 360, and signal terminals 370 and 380. The base 330A is an insulator and can be formed from a plastic or polymer, such as LCP, PE, PTFE, fluoropolymer, or other plastic or insulating material(s). The base 330A is molded around the signal terminals 370 and 380. More particularly, the signal terminals 370 and 380 can be formed from (e.g., stamped, sheared, or otherwise formed out of) a flat sheet of metal, such as a lead frame. In some cases, the sheet of metal or lead frame can be plated with one or more plating metals. The base 330A can be molded around the lead frame from which the signal terminals 370 and 380 are formed, before the signal terminals 370 and 380 are separated from the larger lead frame. The shield terminals 350 and 360 can also be formed from a flat sheet of metal, such as a lead frame.

Referring to FIG. 5C, the shield terminal 350 includes a base plate 351, a contact bend 352, and “J” hooked surface mount tail contacts 353. The shield terminal 360 includes a base plate 361, a contact bend 352, and “J” hooked surface mount tail contacts 363. The base plates 351 and 361 of the shield terminals 350 and 360 can be attached at opposite sides of the base 330A through a heat staking process, using adhesives, mechanical interlocks or interferences, or other means. Referring between FIGS. 5C and 5D, the signal terminal 370 includes a contact bend 372 and a “J” hooked surface mount tail contact 373. The signal terminal 380 includes a contact bend 382 and a “J” hooked surface mount tail contact 383. The surface mount tail contacts 353 and 363 of the shield terminals 350 and 360 can be electrically coupled (e.g., soldered, sintered, etc.) to contact pads of a PCB for ground connections to the PCB. The surface mount tail contacts 373 and 383 can be electrically coupled (e.g., soldered, sintered, etc.) to contact pads of a PCB for signal connections to the PCB. In other examples, the tail contacts of the terminal assemblies 330-333 can be formed as through-hole (e.g., “eye of needle” (EON)) contacts, and other styles of termination contacts can be relied upon in some cases.

As shown in FIG. 5B, the aperture 320 includes opposing or facing inner sidewalls 324 and 325. From the surface mating interface 14B to the socket mating interface 14A of the socket connector 14, the sidewalls 324 and 325 of the aperture 320 include a tapering segment, where the inner sidewalls 324 and 325 become narrower and closer together. The contact bends 352 and 362 of the shield terminals 350 and 360, respectively, contact the sidewalls 324 and 325 of the aperture 320 at a point above the tapering segment, closer to the socket mating interface 14A than to the surface mating interface 14B.

When the plug connector 12 is mated with the socket connector 14, the channel shield 201 of the wafer assembly 51 will be inserted and extend into the aperture 320. In that configuration, the sidewall 201C of the channel shield 201 (see FIG. 2G) will extend between the contact bend 352 of the shield terminal 350 and the sidewall 324 of the aperture 320. Additionally, the sidewall 201D of the channel shield 201 (see FIG. 2G) will extend between the contact bend 362 of the shield terminal 360 and the sidewall 325 of the aperture 320. Because the outer surfaces of the socket housing 60, including all the surfaces within the aperture 320 are plated and conductive, the channel shield 201 is electrically coupled to the side surfaces of the socket housing 60 and the shield terminals 350 and 360 when the plug connector 12 is mated with the socket connector 14. Similarly, the channel shields 201-203 of the wafer assembly 51 will also be inserted and extend into the apertures 321-323 and contact surfaces within the apertures 321-323.

When the plug connector 12 is mated with the socket connector 14, the signal terminals 231 and 232 extending within the channel shield 201 (see FIG. 2F) of the wafer assembly 51 will also be inserted and extend into the aperture 320 and contact the signal terminals 370 and 380 of the terminal assembly 330, respectively. Similarly, the other the signal terminals 233-238 of the wafer assembly 51 will contact other signal terminals of the terminal assemblies 311-333 in the socket connector 14.

FIGS. 5B and 5C also illustrate a grounding stake 340 of the socket connector 14. The socket connector 14 includes a number of grounding stakes, as also shown in FIG. 1B. In the example shown, the socket connector 14 includes a grounding stake at the end of each row of the chicklet and shield terminal assemblies. The grounding stake 340, among others, can be inserted into the socket housing 60 at the position shown and held in place by a mechanical interference, in one example. In other cases, the socket housing 60 can be molded around the grounding stake 340. The grounding stakes can provide additional ground connections in the socket connector 14.

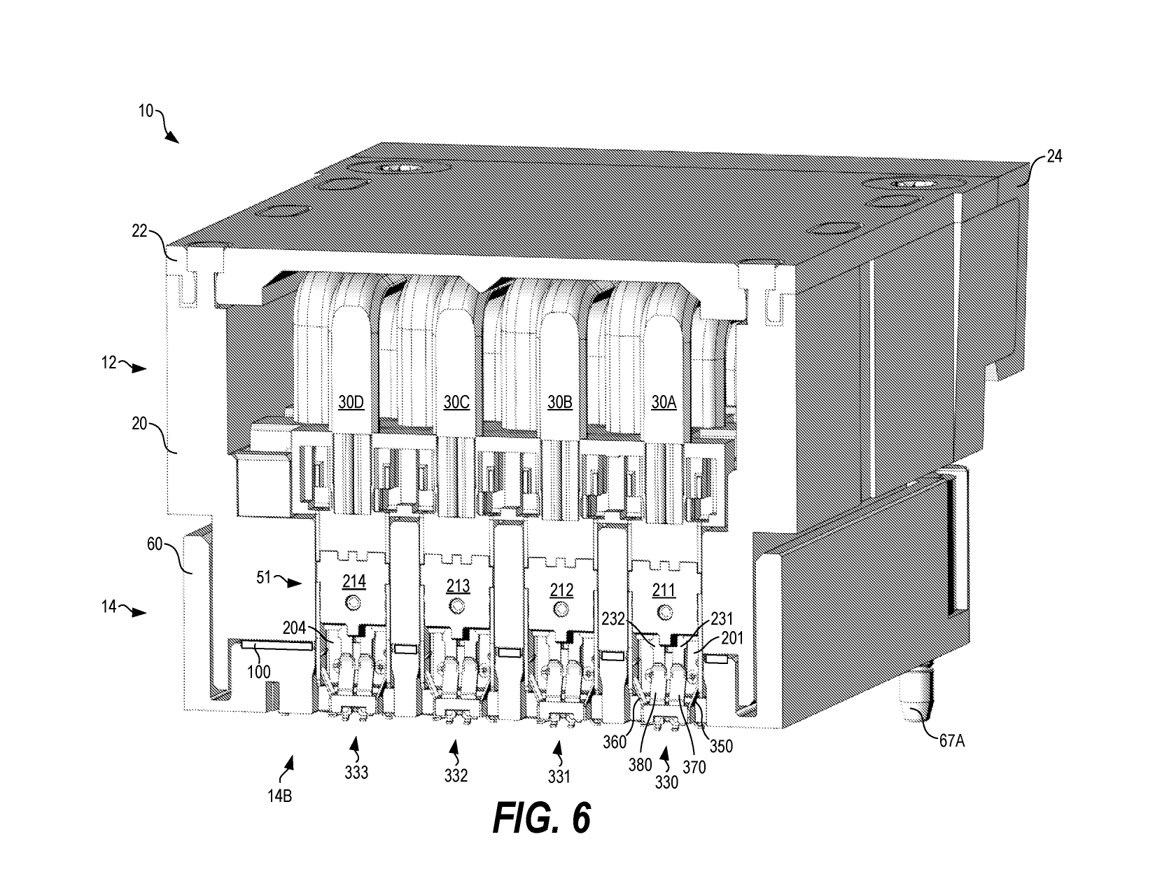

FIG. 6 illustrates a cross sectional view through the connector assembly 10 shown in FIG. 1A according to various aspects of the present disclosure. As shown in FIG. 6, when the plug connector 12 is mated with the socket connector 14, the channel shields 201-204 and signal terminals 231-238 of the wafer assembly 51 are inserted and extend into the apertures 320-323 (see FIG. 5B) of the socket connector 14. The channel shields 201-203 of the wafer assembly 51 contact surfaces of the socket housing 60 within the apertures 321-323. The signal terminals 231 and 232 within the channel shield 201 contact the signal terminals 370 and 380 of the terminal assembly 330, respectively. Similarly, the other the signal terminals 233-238 of the wafer assembly 51 contact other signal terminals of the terminal assemblies 311-333 in the socket connector 14.

The conductive gasket 100 is also shown between the plug connector 12 and the socket connector 14 in FIG. 6. Due to its elastomeric properties, the conductive gasket 100 can be compressed between the socket housing 60 and the plug housing 20, making continuous contact between them, even if the entire surfaces between them have some irregularities. The conductive gasket 100 can help to electrically couple the plug connector 12 with the socket connector 14. The enhanced shielding provided by the conductive gasket 100 helps to maintain signal integrity and higher data throughput for the connector assembly 10.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

What is claimed is:

1. A plug connector, comprising:
a housing, the housing comprising a plated plastic;
a mating interface of the plug connector;
a conductive gasket positioned on an outer surface of the housing in a region of the mating interface; and
a wafer assembly positioned in the housing, the wafer assembly comprising:
a plurality of channel shields;
a pair of signal terminals extending within each of the plurality of channel shields;
a signal terminal insert extending within each of the plurality of channel shields; and
a conductive cable clamp positioned over the plurality of channel shields, wherein:
each of the plurality of channel shields comprises insert tabs that extend into and provide an interference fit with the conductive cable clamp;
the plurality of channel shields extend through apertures in the conductive gasket in the region of the mating interface; and
the conductive gasket comprises a foam multi-laminate having conductive materials disposed in the foam multi-laminate.

2. The plug connector according to claim 1, wherein the housing comprises an insert region and a body region.

3. The plug connector according to claim 2, wherein each of the plurality of channel shields is electrically coupled to the plated plastic of the housing.

4. The plug connector according to claim 1, wherein the insert tabs of each of the plurality of channel shields extend into slits of the conductive cable clamp to provide the interference fit with the conductive cable clamp.

5. The plug connector according to claim 1, further comprising a wafer overmold molded over the conductive cable clamp.

6. The plug connector according to claim 1, wherein each channel shield among the plurality of channel shields extends through a respective aperture in the conductive gasket.

7. The plug connector according to claim 1, further comprising a conductive adhesive between the conductive gasket and the outer surface of the housing in the region of the mating interface.

8. A connector assembly, comprising:
a plug connector; and
a socket connector, wherein:
the plug connector comprises a plug housing, a plug mating interface, a conductive gasket positioned on an outer surface of the plug housing in a region of the plug mating interface, and a wafer assembly positioned in the housing;
the wafer assembly comprises:
a plurality of channel shields;
a pair of signal terminals extending within each of the plurality of channel shields; and
a conductive cable clamp positioned over the plurality of channel shields, each of the plurality of channel shields comprising insert tabs that extend into and provide an interference fit with the conductive cable clamp;
the socket connector comprises a socket housing and a socket mating interface;
the conductive gasket is positioned between the plug mating interface and the socket mating interface;
the plurality of channel shields extend through apertures in the conductive gasket in the region of the plug mating interface; and
the conductive gasket comprises a foam multi-laminate having conductive materials disposed in the foam multi-laminate.

9. The connector assembly according to claim 8, wherein:
the plug housing comprises a conductive plated plug plastic housing; and
the socket housing comprises a conductive plated socket plastic housing.

10. The connector assembly according to claim 8, further comprising a conductive adhesive between the conductive gasket and the outer surface of the plug housing in the region of the plug mating interface.

11. The connector assembly according to claim 8, wherein the wafer assembly further comprises a signal terminal insert extending within each of the plurality of channel shields.

12. The connector assembly according to claim 11, wherein:
the plug housing comprises a conductive plated plug plastic housing; and
each of the plurality of channel shields is electrically coupled to the conductive plated plug plastic housing.

13. The connector assembly according to claim 11, wherein the insert tabs of each of the plurality of channel shields extends into slits of the conductive cable clamp to provide the interference fit with the conductive cable clamp.

14. The connector assembly according to claim 11, further comprising a wafer overmold molded over the conductive cable clamp.

15. The connector assembly according to claim 11, wherein each channel shield among the plurality of channel shields extends through a respective aperture in the conductive gasket.

16. The connector assembly according to claim 11, wherein:
the plurality of channel shields comprise a plurality of contact dimples;
the socket housing comprises a conductive plated socket plastic housing; and
the plurality of contact dimples contact surfaces of the conductive plated socket plastic housing.

17. A connector, comprising:
a housing;
a conductive gasket positioned on an outer surface of the housing; and
a wafer assembly positioned in the housing, the wafer assembly comprising:
a plurality of channel shields;
a pair of signal terminals extending within each of the plurality of channel shields; and
a conductive cable clamp positioned over the plurality of channel shields, wherein:
each of the plurality of channel shields comprises insert tabs that extend into and provide an interference fit with the conductive cable clamp;
the plurality of channel shields extend through apertures in the conductive gasket; and
the conductive gasket comprises a foam multi-laminate having conductive materials disposed in the foam multi-laminate.

18. The connector according to claim 17, wherein the housing comprises a conductive plated plastic housing.

19. The connector according to claim 18, wherein each of the plurality of channel shields is electrically coupled to the conductive plated plastic housing.

20. The connector according to claim 17, wherein each channel shield among the plurality of channel shields extends through a respective aperture in the conductive gasket.
